(19) United States
(12) Patent Application Publication
(10) Pub. No.: US 2019/0043059 A1
(43) Pub. Date: Feb. 7, 2019

(54) MONITORING SUPPLY CHAINS, AUTHENTICATING GOODS AND AUTHORIZING PAYMENT

(71) Applicant: Valida, Inc., San Francisco, CA (US)

(72) Inventors: Bin Xie, San Jose, CA (US); Paul Borchardt, San Francisco, CA (US); Yuqi Wang, San Jose, CA (US); Charles Walter, Mountain View, CA (US); Nicholas Harvey, Pleasanton, CA (US); Kieran McCarthy, San Francisco, CA (US); John Aynsley, Belmont, CA (US)

(21) Appl. No.: 14/938,833

(22) Filed: Nov. 11, 2015

Related U.S. Application Data
(60) Provisional application No. 62/078,276, filed on Nov. 11, 2014.
(60) Provisional application No. 62/157,476, filed on May 6, 2015.

(51) Int. Cl. G06Q 30/00; G06Q 20/40

(52) U.S. Cl. CPC G06Q 30/0185; G06Q 20/40

(57) ABSTRACT

In one aspect of specific embodiments, methods are provided for monitoring a supply chain, including detection of the gray market, stolen, or counterfeit goods. In another aspect of specific embodiments, methods are provided for determining an authenticity of goods during a payment process, and reporting authenticity results to an actor in the payment process to allow that actor to determine whether to complete or cancel the process. In some embodiments, at least one of an open key, hidden key, authentication request counter, and optionally, authentication request timer are associated in an authentication database with an item in an authentication server.

### CROSS REFERENCE TO RELATED APPLICATIONS

This application claims priority from U.S. provisional patent application 62/078,276 filed on Nov. 11, 2014 entitled MONITORING SUPPLY CHAINS AND AUTHENTICATING GOODS and from U.S. provisional patent application 62/157,476 filed on May 6, 2015 entitled ITEM AUTHENTICATION AND PAYMENT AUTHORIZATION. All referenced documents and applications herein and all documents referenced therein are incorporated by reference for all purposes.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### BACKGROUND

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

The counterfeiting of goods is an increasing problem world-wide owing to increased global trade and the presence of improved manufacturing and packaging technologies that include the ready availability of digital scanners and printers that can thus be used by counterfeiters to make harder to detect counterfeit goods. Besides the economic impact, estimated at over $200 billion annually in lost revenue, counterfeit goods endanger health and safety.

As one example, a significant portion of medicines in the developing world are counterfeit and do not contain the correct drugs, contain inadequate quantities of the correct drugs, contain unapproved drugs or excipients or were manufactured under non-hygienic conditions. Additionally, counterfeit mechanical and electrical components may not meet engineering or product testing requirements, thereby endangering the users of products such as cars and planes that incorporate the counterfeit components, e.g., brake pads, bolts, microchips. Various other counterfeit or unauthorized consumer or commercial goods negatively impact manufacturers, merchants, and customers.

### SUMMARY

In various specific embodiments, systems and methods as described herein provide a authentication server that communicates with multiple actors in a supply chain and/or payment processing chain to authenticate goods. Novel systems and methods as described herein in some embodiments provide a simple way various actors to determine if an item is “authentic.” According to further specific embodiments, completing payment for the item is predicated on first determining whether an item is authentic. The term “authentic” in various embodiments can be understood to include whether an item is “valid” at the time of authentication. For example, a genuine item may be invalid due to being resold, being recalled, being reported stolen, being expired, being outside of an authorized distribution chain, etc. In specific embodiments, a user of a system in a supply chain receives a simple indication that a product is authentic or not authentic. In other embodiments, a user receives a simple indication that a product is authentic or not authentic and can then either to decide to complete or cancel the payment for the product.

While various users may receive only an authentic or not authentic indication, the authentication server may collect and store numerous parameters about a particular item and may base an authentication determination on many parameters. The combination of ease of use at supply chain authentication points or during a purchase and a server that is able to receive authentication data from multiple points and optionally make multi-factorial authentication provides significant advantages not available with present systems.

According to specific embodiments, methods and systems as described herein, provide flexible authentication and supply chain tracking. In some embodiments, authentication uses at least one open key that is associated with an item in trade and that is scanned or otherwise read or determined and transmitted to an authentication server at various points in a supply chain, or during a purchase. Optionally, a hidden key can also be associated with an item in an authentication process. Both open keys and hidden keys can be nested as further described herein.

When used, hidden keys generally are associated with an item in such a way so that their use indicates that some non-reversible action has been taken with respect to an item. For example, an authentication using a hidden key that is on the inside lid of a medicine bottle or cork of a wine bottle allows the authentication server to know that a nonreversible action has taken place with respect to that item, e.g., opening the bottle. Likewise, use of a hidden key that requires the key to be revealed by opening a packaging or removing a label or covering, also indicates to the authentication server that a first sale has taken place. In the case of nested keys, an open key present on items inside a larger packaging can act as a hidden key for the larger packaging, e.g., when an open key on an inside item is authenticated, the system knows that the larger packaging has been nonreversibly opened.

Items may be scanned or read for keys in any number of ways as appropriate for different levels of a supply chain, or different purchasing or payment methods. Reading keys may be accomplished by a portable, semi-portable, or fixed device that is otherwise in use during item distribution, such as a cash register scanner, an inventory scanner or control system, a shipping scanner or control system, etc. Reading keys also may be accomplished by a portable, semi-portable, or fixed device that is specific for authentication otherwise in use during item distribution, such as a cash register scanner, an inventor scanner or control system, a shipping scanner or control system, etc. Reading keys also may be accomplished by a portable, semi-portable, or fixed device that is a more general purpose device programmed for authentication, such as a mobile phone, tablet computer, personal computer, or similar device. Reading keys also may be accomplished by a “smart” device or system, such as a smart refrigerator, smart home, smart wine-cooler, smart medicine cabinet, etc.

Open or hidden keys can be attached to an item and read in such a way that it would be difficult for an authentication requester to submit the authentication request without the item being physically present. An open key or hidden key may be printed using a bar code with a proprietary encryption scheme that requires a particular bar code application to read. An RFID or similar tag can also include encrypted data that is only decryptable by an authorized reader.

An authentic or not-authentic indication can be provided in various ways, as appropriate for the supply chain level or payment processing system. An authentication indication may be presented (such by a display or sound) by a device that is performing a reading. Alternately, an authentication indication may be presented in a report, stored in a database, transmitted via text message, email, fax, message on a website, telephone, etc., as implemented by specific systems and optionally also as configured by a user.

Authentication according to specific embodiments is incorporated into a payment processing system in such a way that receiving an authentic indication is necessary to complete a transaction. For example, the positive authentication of an item may be required before credit card sales, other non-cash sales (e.g., other credit, debit, Paypal, Google Wallet, Apple Pay, Bitcoin or other cryptocurrency, etc.) or other transactions can be completed. Also, one or more incentives, such as warranty registration, may be provided to users to authenticate or register an item.

Systems and methods as described herein can optionally provide further functionality based on receiving and responding to authentication requests throughout the supply chain. Product recall, marketing, expiration warnings, etc., can all be incorporated into such a system.

Specific embodiments as described or claimed herein are involved with methods and/or systems and/or devices and/or processes and/or apparatus that can be used together or independently to provide item authentication for payment processing and/or supply chain monitoring using one or more information systems configured as described herein and optionally in communication with other information systems or devices as described herein or as known in the art using any known or available communication media. Some embodiments described in this document are directed at the technical problem of supply chain monitoring and item authentication during payment processing generally and some are directed in particular at the technical challenge of distributed information handling systems able to provide simple point-of-use authentication of items while allowing multi-factorial authentication decisions to be made and recording supply chain parameters. Various embodiments are compatible with distributed and networked computing systems, but do not necessarily incorporate all the elements of a computer network.

This summary introduces a selection of concepts that are further described or can be further understood from this application as a whole, including the attached claims, read in light of the known art. Important features of the claimed subject matter are discussed throughout this submission including in any supplied appendix, thus no individual part of this submission is intended to determine the scope of the claimed subject matter. The various examples given throughout this application are merely illustrative of specific embodiments and do not limit the scope of claimed embodiments beyond the attached claim language. This Summary is not intended to identify key features or essential features of the claimed subject matter, nor is it intended to be used to limit the scope of the claimed subject matter. The various innovations described herein are defined by the claims.

As used herein, “include” or “involved with” allows additional elements unless otherwise stated. “Automatically” means by use of automation (e.g., computing hardware configured by software for specific operations and technical effects discussed herein), as opposed to without automation. In particular, steps performed “automatically” are not performed by hand on paper or in a person's mind, although they may be initiated by a human user or guided interactively by a human user. Automatic steps are performed with a machine in order to obtain one or more technical effects that would not be realized without the technical interactions thus provided. One of skill understands that technical effects are the presumptive purpose of a technical embodiment. The mere fact that calculation is involved in an embodiment, for example, and that some calculations can also be performed without technical components does not remove the presence of the technical effects or alter the concrete and technical nature of the embodiment. “Computationally” likewise means a computing device (processor plus memory, at least) is being used, and excludes obtaining a result by mere human thought or mere human action alone. Computational results are faster, broader, deeper, more accurate, more consistent, more comprehensive, and/or otherwise provide technical effects that are beyond the scope of human performance alone. “Computational steps” are steps performed computationally. “Computationally” and “automatically” are used interchangeably herein. The optional plural “(s)”, “(es)”, or “(ies)” means that one or more of the indicated feature is present. For example, “variable(s)” means “one or more variables” or equivalently “at least one variable”.

Some embodiments described herein may be viewed in a broader context. Nevertheless, the present disclosure is focused on providing appropriately specific embodiments whose technical effects fully or partially solve the particular technical problems discussed herein. Systems and methods involving authentication or purchasing using computing systems in general and not in accordance with the attached claims are outside the present scope. Thus, the claimed embodiments, when considered under a proper understanding of the present disclosure, do not attempt to claim any abstract ideas. The technical character of embodiments described herein will be apparent to one of ordinary skill in the art and to general readers. Specific embodiments are directed to the technical problems of providing automated authentication and tracking of a item in trade in a supply chain using information processing and communication channels. Specific embodiments include technical components such as information processing hardware that interacts with software in a manner beyond the typical interactions within a general purpose computer.

### BRIEF DESCRIPTION OF THE DRAWINGS

FIG. 1 is a flow chart illustrating a simple supply chain with four distribution levels consisting of a goods manufacturer (Level 1), a wholesaler (Level 2), a retailer (Level 3) and a consumer (Level 4).

FIG. 2 is a block diagram illustrating the use of a portable wireless device, e.g., a smartphone, an inventory or sales scanner, a smart home or smart appliance scanner, etc., to carry out a standalone authentication process that does not require contemporaneous communication with the authentication server. In one embodiment, the portable wireless device is used for data acquisition, communication with the authentication server and the outputting of the authentication results to the device user. The authentication server performs the necessary data processing steps and authentication steps. In some embodiments, the portable wireless device provides to the authentication server keys required for authentication. Alternatively, one or more open keys or hidden keys are obtained by the authentication server through interrogation of the authentication database or through some other data input.

FIG. 3 is a block diagram illustrating the use of a portable wireless device to carry out the authentication process, wherein the portable wireless device is in contemporaneous communication with an authentication server. In some embodiments, the portable wireless device is used for data acquisition, communication with the authentication server and the outputting of the authentication results to the device user. The authentication server performs the necessary data processing steps and authentication steps. In some embodiments, the portable wireless device provides to the authentication server keys required for authentication. Alternatively, one or more open keys or hidden keys are obtained by the authentication server through interrogation of the authentication database or through some other data input.

FIG. 4 is an authentication flowchart illustrating one embodiment of the authentication steps performed by the authentication server to authenticate an item at one level of the supply chain.

FIG. 5 is an authentication flowchart illustrating an alternate embodiment of the authentication steps performed by the authentication server to authenticate an item at one level of the supply chain.

FIG. 6 is a table illustrating an example of data collected and compared with the authentication database and possible authentication messages sent to users according to specific embodiments.

FIG. 7 illustrates a prior art payment processing scheme currently used for credit cards, debit cards, prepaid cards and mobile payment apps. This payment processing scheme lacks a product authentication step and thereby allows a customer to unwittingly purchase counterfeit, expired, recalled or stolen goods. For simplicity, the card network is not shown in the flowchart.

FIG. 8 illustrates one method of incorporating a product authentication step into the payment processing scheme. In this example, a Customer sends an authentication query request to an authentication server that queries an authentication database (Step 1). The query request typically includes at least one form of unique product identifier, for example a serial number or hidden key. The authentication server queries the authentication database to see if the unique product identifier sent by the customer is recorded in the authentication database and associated with the product. The authentication server then sends the authentication results to the Customer (Step 2). For simplicity, the card network is not shown in the flowchart.

FIG. 9 illustrates an alternate method of incorporating an authentication step into the payment processing scheme. In this example, a Customer sends an authentication query request to an authentication server that queries an authentication database (Step 1). The authentication server then sends the authentication results to the Issuing Bank (Step 2). The Issuing Bank makes a preliminary payment authorization decision based in part on the likelihood of the item's authenticity. The preliminary payment authorization decision is sent to the Merchant and/or Customer (Step 3). For simplicity, the card network is not shown in the flowchart.

FIG. 10 illustrates an additional method of incorporating an authentication step into the payment processing scheme. In this example, the Customer sends an authentication query request to an authentication server through an authentication mobile app or indirectly through a mobile payment app that is enabled to send queries to the authentication server (Step 1). The authentication server then sends the authentication results to the Merchant (Step 2). For simplicity, the card network is not shown in the flowchart.

FIG. 11 illustrates a further method of incorporating an authentication step into the payment processing scheme. In this example, the Merchant sends a query request to the authentication server (Step 2). The authentication server then sends the authentication results to the Merchant (Step 3). For simplicity, the card network is not shown in the flowchart.

FIG. 12 illustrates another method of incorporating an authentication step into the payment processing scheme. In this example, a Customer sends an authentication query request to an authentication server that queries an authentication database (Step 1). The authentication server then sends the authentication results to the Payment Processor (Step 2). For simplicity, the card network is not shown in the flowchart.

FIG. 13 illustrates an alternate method of incorporating an authentication step into the payment processing scheme. In this example, the Merchant sends a query request to the authentication server (Step 2). The authentication server then sends the authentication results to the Issuing Bank (Step 3). For simplicity, the card network is not shown in the flowchart.

FIG. 14 illustrates a further method of incorporating an authentication step into the payment processing scheme. In this example, the Merchant sends a query request to the authentication server (Step 2) The authentication server then sends the authentication results to the Payment Processor (Step 3).For simplicity, the card network is not shown in the flowchart.

FIG. 15 illustrates an additional method of incorporating an authentication step into the payment processing scheme. In this example, the Payment Processor sends a query request to the authentication server (Step 3). The authentication server then sends the authentication results to the Payment Processor (Step 4).For simplicity, the card network is not shown in the flowchart.

FIG. 16 illustrates an further method of incorporating an authentication step into the payment processing scheme. In this example, the Issuing Bank sends a query request to the authentication server (Step 4). The authentication server then sends the authentication results to the Issuing Bank (Step 5). For simplicity, the card network is not shown in the flowchart.

FIG. 17 is a block diagram showing a representative example logic device in which various aspects of the present invention may be embodied.

### DETAILED DESCRIPTION OF SPECIFIC EMBODIMENTS

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. Many modifications and variations will be apparent to those of ordinary skill in the art without departing from the scope and spirit of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. For example, the phrase “a hidden key” includes a plurality of hidden keys. As used throughout this application, the word “may” is used in a permissive sense (i.e., meaning having the potential to), rather than the mandatory sense (i.e., meaning must). Similarly, the words “include,” “including,” and “includes” mean including, but not limited to. The headings used herein are for organizational purposes only and are not meant to be used to limit the scope of the description or the claims.

As used herein, the term “supplier” includes any provider of an article, item or good including a grower, manufacturer, producer, assembler, wholesaler, retail establishment, auctioneer, consignment seller or internet based seller, including a user of an auction type website, such as EBay.

As used herein, the term “item” includes any physical object, material, partial or finished component, assembly, product, article or good. Finished items include, but are not limited to, various luxury goods including, clothing, footwear, handbags, watches, perfume, works of art, jewelry and cut gemstones; collectables including coins, stamps, porcelain and sports memorabilia; consumer goods, including clothing, sportswear, footwear, athletic and sporting goods; tires; pharmaceuticals including controlled substances; beauty products; personal care products; foodstuffs; alcohol, including spirits and wine; cigarettes; formulated chemicals including pesticides, herbicides and insecticides; household furnishings; carpets; electronics, including cell phones, televisions, computers, and tablets; mechanic equipment, including pumps, centrifuges, engines, turbines and lathes; computer software; video, audio and data tapes, CDs, DVDs and other forms of data storage; online data or media that can be downloaded, prepaid cards for communication or other services.

Components include car, truck, tractor, train, airplane, helicopter and other machine parts; integrated circuits (computer chips), mother boards and video screens for computers, cell phones and other electronic products.

Materials include chemicals; active pharmaceutical ingredients; uncut semi-precious and precious gemstones; raw or unprocessed food, including fruit, meats, grains, spices, herbs, vegetables and organic certified food. Items further include documents and agreements, currency, identification badges, passports, financial instruments, including, bank checks, bank drafts, certificates of deposit, bond certificates including bearer bonds, treasury bonds and bonds issued by governments, commercial papers, stock certificates, demand drafts, bills of exchange, letters of credit, future and option contracts and debt instruments.

The terms “requester” or “authentication requester” are used herein to denote a user of the disclosed supply chain monitoring and authentication system and/or payment authorization system. Requesters include any person or entity, whom is not an authentication database administer, that contacts the authentication server with the intent to query the authentication database or to request an update or modification of the authentication database.

In one aspect of specific embodiments, methods are provided for monitoring a supply chain, including the authentication of goods. The methods are applicable to a supply chain of any length and also to aftermarket sales, i.e., the sale of second-hand and other used or previously owned goods. The methods provide a means of monitoring a supply chain and enable the detection and tracking of counterfeit, gray market and stolen goods introduced into the supply chain including at the retail market level.

In another aspect of specific embodiments, methods are provided for authorizing payment for the purchase of goods. The methods are applicable to store-based, fixed or mobile payment platforms and systems. The methods provide a means of predicating payment authorization on the successful authentication of an item. The methods prevent the purchase of counterfeit, knockoff, gray market, expired, stolen, recalled or otherwise unauthorized items.

Keys Associated with Items

### Open Keys

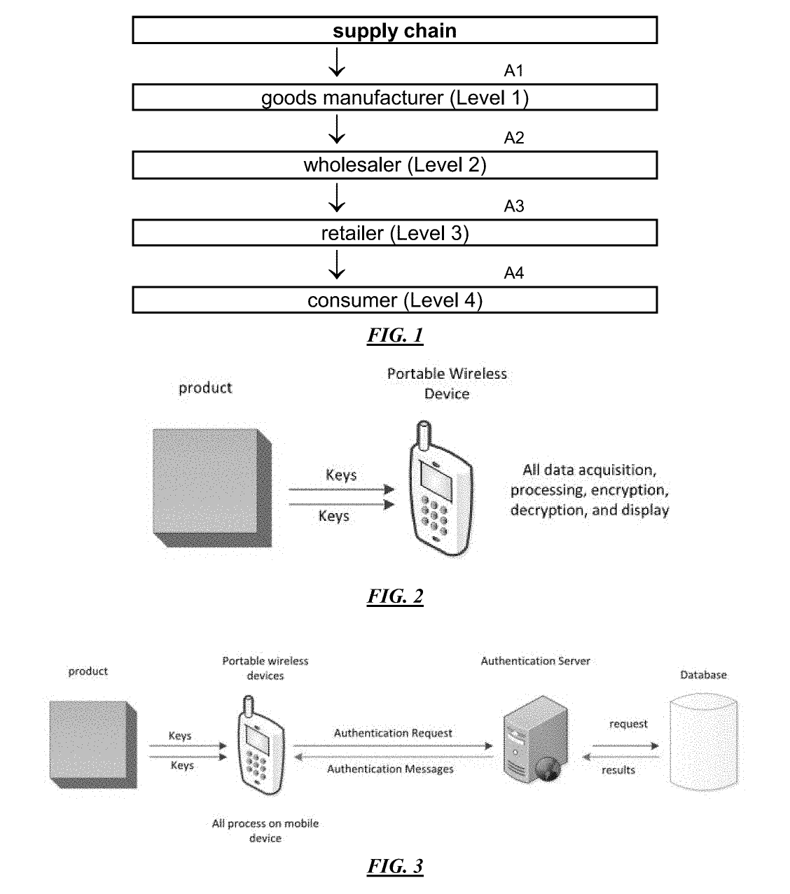

A general description of the components utilized in the practice of the disclosed methods is provided below. In some embodiments of the methods, a supplier, e.g., a manufacture, producer, assembler or distributor, labels a finished or partial item with one or more open keys, of which generally at least one open key is unique to that item, i.e., a unique product identifier (UPI). In additional embodiments, all open keys are unique to the item. Open keys typically comprise a sequence of alphanumeric characters but other characters or symbols or tags or identifiers can be used, such as punctuation marks, barcodes, QR codes, RFID or other digitally readable codes, etc. Open keys are visible or otherwise generally known or perceivable to the casual observer and generally are not hidden or obscured from view and do not require opening or altering a packaging at a particular level of distribution to read. In further embodiments, an open key can be a product serial number. According to specific embodiments, open keys for items in a supply chain are recorded one or more times in one or more authentication databases during movement or distribution of the item through the supply chain. (See, e.g., FIG. 1)

According to specific embodiments, in some cases open keys are used to authenticate an item at each level of the supply chain as it moves through the supply chain. Generally, authentication results are provided in substantially real time allowing items to be accepted or rejected in a timely manner that does not impede the flow of commerce.

### Hidden Keys

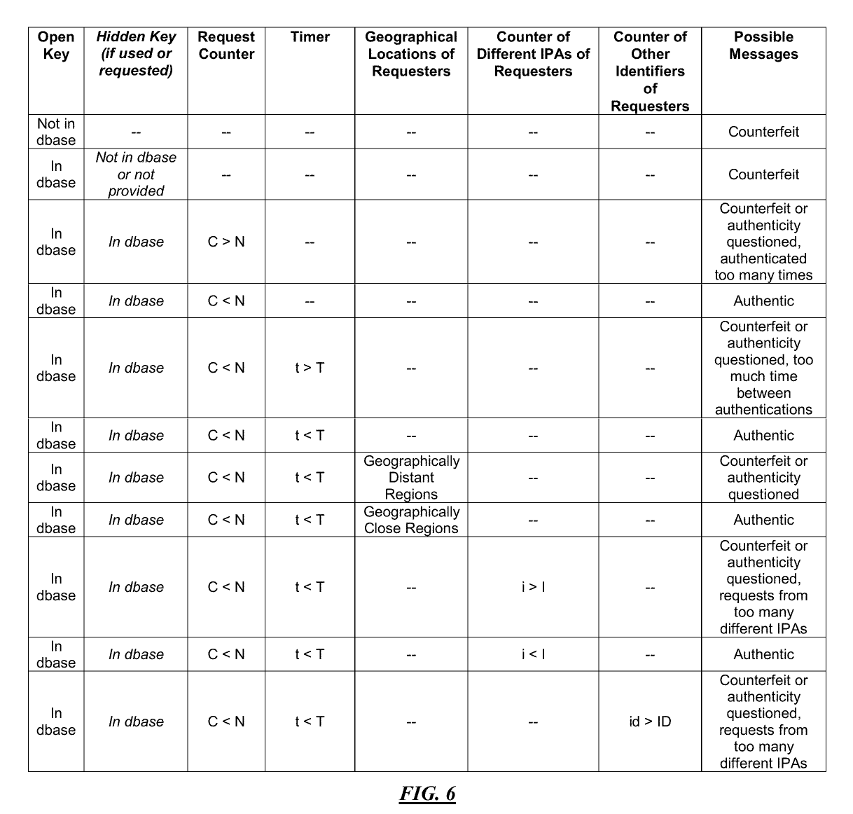

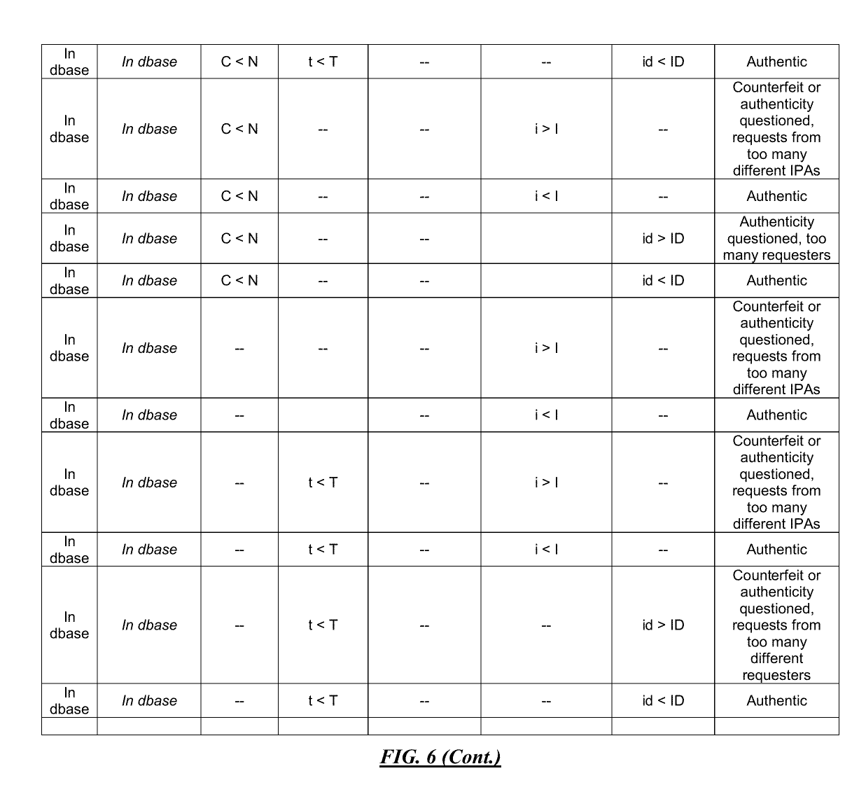

According to further embodiments, in addition to open keys, one or more hidden keys are also assigned to the item and are recorded in a database (e.g. FIG. 6). Hidden keys generally are not visible or perceivable to a casual observer of an item at a particular distribution level. Frequently, at least one hidden key is a UPI. Typically, hidden keys comprise a sequence of alphanumeric characters but other characters or symbols can be used such as punctuation marks or barcodes or QR codes and other identifiers such as RFIDs can be used. In some embodiments, the hidden keys are placed on or in close proximity to the item, e.g., inside a sealed box containing the item. In other words, the hidden keys exist physically as printed characters or symbols and are physically associated with an item.

In other embodiments, the hidden keys are not physically associated with an item. For example, one or more hidden keys are not provided on or with an item, or on or in the item's packaging, but instead, the hidden keys are provided separately to the purchaser. In some embodiments, a hidden key is sent to a purchaser at the time of purchase or at the time of shipment. In further embodiments, one or more hidden keys are assigned to an item and stored in the authentication database, but are not released to an initial purchaser or distributor of a good. In some embodiments, the hidden key is associated with an invoice, bill of lading number or shipping manifest number. Requiring the use of a hidden key that is not physically associated with an item can detect attempts to authenticate an item by someone other than the authorized receiver of the item.

In some embodiments, usually for high value items and/or items that are typically packaged singularly for distribution, e.g., jewelry or a refrigerator, at least one hidden key is unique to that particular item. In further embodiments, multiple items are associated with a particular hidden key.

There are many ways in which to attach, insert, incorporate or otherwise physically associate a hidden key (or an open key) with an item. In some embodiments, the hidden key is printed on, inserted into or attached to the inside of an item, such as a closed compartment of a refrigerator, the inside of a cap on a jar or a bottle or the hidden portion of a non-replaceable label that must be removed to open the bottle. In other embodiments, the hidden key is attached to, affixed or printed on the item and the hidden key is concealed from plain view through the use of one or more tamper evident techniques, such as an opaque protective covering such as a scratch off covering, a tear off covering or other tamper evident covering. In further embodiments, the hidden key is attached to, affixed or printed on a component or subcomponent of the item and the hidden key is concealed from plain view by the finished assembled item.

In additional embodiments, the hidden key is inserted into, affixed to or incorporated into a container or closure that holds the item and the sealed container or closure hides the hidden key from plain view. For example, the hidden key may be printed or affixed to the inside of a bottle cap of a container that holds the item, like liquor. In additional embodiments, the hidden key may be printed or affixed to the inside of a box or other form of packaging the holds the item. Alternately, the hidden key is printed or affixed to the outside of the box or package and is concealed from plain view through the use of an opaque protective covering such as a scratch off covering, a tear off covering or other tamper evident covering. In other embodiments, the hidden key is inserted into, affixed to or incorporated into a product insert that may be placed inside a bottle or box containing the item. In some instances, the product insert is a warranty or registration card, or operating instructions.

In other embodiments, one or more hidden keys are shared among a plurality of individual items. In some embodiments, the items that share one or more hidden keys are identical, e.g., all bottles of wine from a particular bottling run or vintage, or one or more cases containing bottles of wine from the bottling run or vintage. For example, identical items that are typically packaged as multiple units for shipment can share one or more hidden keys, e.g., bottles of wine in a case or pills packaged in a blister pack.

In alternate embodiments, the items that share one or more hidden keys are dissimilar. For example, a supplier may pack multiple items representing different product lines into a box for shipment, each item in the shipping box sharing one or more hidden keys with the rest of the items in the box. As a further example, a winery may ship to a wholesaler by multimodal container cases of wine from different vintages, wherein all the cases in the shipment sharing one or more hidden keys. In further embodiments, one or more shared hidden keys are assigned to items that will be sent as one or more shipments to an entity in a supply chain (FIG. 6). Similarly, one or more shared hidden keys are assigned to items that represent the items on an invoice, letter of credit, shipping manifest, etc.

In other embodiments, different hidden keys are assigned to different sized units of packaging in a shipment, e.g., an item may have a hidden key assigned to it as a single unit, another hidden key assigned to as part of a multi-unit box, a further hidden key assigned to it as part of a case of multi-unit boxes and an additional hidden key assigned to it as part of a pallet of cases of multi-unit boxes. In some embodiments, different hidden keys are assigned to different locations on an item, package or enclosure containing the item, or shipping container, e.g., box or pallet. For example, an item in a single unit package may have one hidden key placed on the exterior of the package and an additional hidden key placed inside the package. The single unit package may then be placed into a multi-unit box for shipping to a wholesaler with the exterior of the multi-unit box labeled with one hidden key and the interior of the multi-unit box labeled with another hidden key. When nested, a hidden key may become an open key as nested packaged items move through a supply chain.

In additional embodiments, different hidden keys are assigned to different levels on the distribution chain, e.g., retail or wholesale. In other embodiments, different hidden keys are assigned to different buyers or recipients on the same level of the distribution chain.

### Other Options

In some embodiments, a preliminary authentication procedure is performed with an open key with a hidden key reserved for confirmatory authentication, if required. In other embodiments, the last or the second to last level of the supply chain requires the use of one or more hidden keys for authentication purposes, while the use of hidden keys in the other levels of the supply chain is for confirmatory authentication, if required.

In other embodiments, radio frequency identifiers (RFIDs) may be used in addition to open and hidden keys. In some embodiments, to speed or otherwise enable efficient scanning and/or tracking of items, a preliminary authentication procedure is performed using RFIDs with open keys and hidden keys reserved for confirmatory authentication, if required. Typically, RFID are only employed at the top levels of a supply chain, e.g., manufacturer, distribution center including wholesale distributer, or materials handling facility.

### Additional Keys

In additional embodiments, persons or entities that take possession of an item at some point in the supply-chain may request from the administrator of the supply chain and authentication system permission to register one or more additional open and/or hidden keys that are associated with the item. In further embodiments, the additional open or hidden key is printed or applied to the item, the item's packaging or the item's shipping container by the requester. In other embodiments, the additional open or hidden key is only associated with a concept or other classification.

In further embodiments, at one level of the supply chain, the authenticity of an item may be checked at several levels of packaging. For example, a pallet of items can be authenticated, a multi-unit box from the pallet can be authenticated and finally, an individual item extracted from the multi-unit box can be authenticated.

### Nested or Supply Chain Authentication

In some embodiments, the authentication of an item at a particular distribution level is dependent of the item having been successively authenticated in one or more higher distribution levels. For example, a retail customer initiating a purchase will not receive confirmation of authenticity of an item or approval to purchase if the retail store and/or wholesaler did not successfully authenticate the item. By requiring successful authentication at each level of the distribution chain, i.e., chaining or linking the authentication results of each distribution level, the incentive to introduce stolen or gray market items can be reduced because potential buyers further down the supply chain will not be able to successfully authenticate the item, thereby reducing the value of the stolen or gray market items.

In some embodiments, at the final level of the chained supply chain, the requester is not initially required to supply one or more hidden keys with the authentication request. For example, a retail consumer initially only needs to supply an open key for authentication, but if other data indicates a high degree of probability that the item is counterfeit, the retail consumer can be required to supply one or more hidden keys in order for the item to be authenticated.

### Different Ways of Affixing Keys

Open and hidden keys can be readable by a human or can be encoded into machine readable forms. Numerous types of optically readable forms are available such as linear barcodes and matrix (2D) barcodes including Aztec code, Code 1, ColorCode, Color Construct Code, CrontoSign, CyberCode, d-touch, DataGlyphs, Data Matrix, Datastrip Code, EZcode, High Capacity Color Barcode, HueCode, InterCode, MaxiCode, MMCC, NexCode, PDF417, Qode, QR code, ShotCode and SPARCode.

The open and/or hidden keys can be printed on the item, item's label, insert, packaging or shipping container using any well-known printing technologies such as ink-jet, solid-ink, laser-, intaglio-, letterpress-, offset-, screen-, gravure-flexo-graphic printing or coating techniques. Alternately, the open and/or hidden keys can be embossed, etched, engraved or stamped on the item, item's label, insert, packaging or shipping container. Further, the open and/or hidden keys can be molded or otherwise incorporated into the item or its container or enclosure.

In additional embodiments, open and hidden keys may be reassigned as needed to reflect a change in a distribution scheme, for example, the creation of a security interest, a bailer-bailee relationship or the resale of an item.

### Authentication Server and Database

According to specific embodiments, an authentication database is configured to receive and store various data relevant to authenticating an item at one or more points in a supply chain. Examples of such data according to specific embodiments include administrator information, original manufacturer or supplier information, product name, product category, model number, lot number, serial number, production run, date of manufacture, lot number, expiration date, release or testing results, release date, other product description information, invoice number, shipping time and date, shipping waybill number, shipping agent, shipping route, receiving party's name and address, shipping insurance information, insurance coverage, open keys, hidden keys, authentication request counters, dates and times of authentication requests, time interval between authentication requests, number of successful or unsuccessful authentication requests, geographical locations of authentication requesters, internet protocol addresses (IPA) of authentication requesters, and/or return messages. Specific embodiments may include any desired number of these data values, or other values, useful in tracking and authenticating an item.

One or more various authentication databases can be variously administered as will be understood in the art. Storage, modification and retrieval of data in the database happens via various authorized transactions as described herein. Typically, only the database administrator and one or more authorized users, such as the original manufacture can edit information stored in the database including the assignment of open and hidden keys.

### Standalone and Connected Authentication

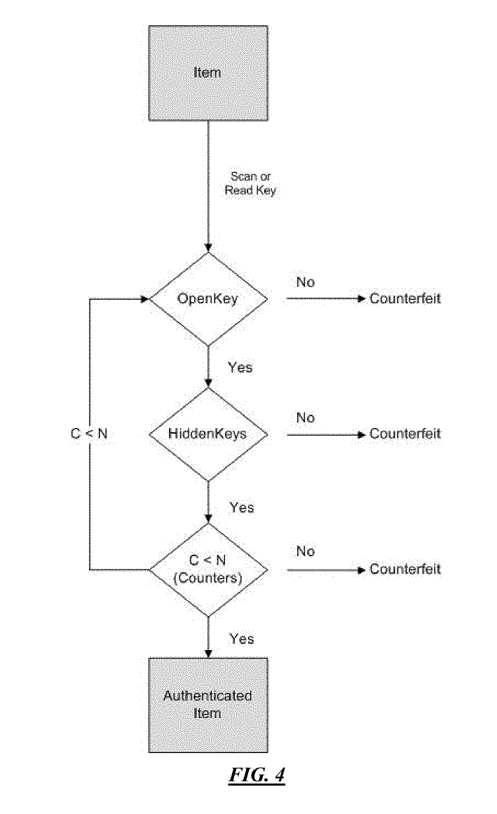

Depending on the particular implementation used by a recipient of an item or a potential customer, with respect to connection to a central authentication server, various authenticity schemes are possible (FIG. 2-3). A standalone (off-line) method for monitoring the supply chain and/or checking authentication of an item that does not require a contemporaneous connection with the authentication server is illustrated in FIG. 2. For convenience, the illustrated method shows a portable wireless device that contains the relevant keys, but it is to be understood that a fixed system or a hybrid system, i.e., the use of a portable wireless device previously or contemporaneously in contacted with the client's server can be used instead. In the illustrated method, one or more open keys and/or one or more hidden keys were previously provided to the user from the authentication server and are stored on the portable wireless device. Next, the portable wireless device captures keys and other identifying information from the item to be authenticated or it is manually or verbally inputted. The portable wireless device then performs all of the necessary data processing steps using locally available software. The open and optionally hidden keys are compared to the keys previously received from the authentication server. The portable wireless device generates and outputs the results of the authentication request to the user.

A method for monitoring the supply chain and authenticating items that uses a contemporaneous communication with the authentication server is illustrated in FIG. 3. For convenience, the illustrated method shows a portable wireless device that is in communication with the authentication server, but it is to be understood that a portable or substantially fixed system (e.g., a desktop computer) can be used. Additionally, the device can also be communication with a payment processing system. In the illustrated embodiment, the portable wireless device is used for one or more of data acquisition, communication with the authentication server, receipt of the verification results and display of the results to the user. The authentication steps are performed by the authentication server. Optionally, the portable wireless device can be in communication with a payment processing system with authentication steps initiated by various actors in the payment processing system as describe herein.

Communications between the various actors and devices can be accomplished using BlueTooth, WLAN, WAP, i-mode, SMPP protocols within GSM, TDMA, CDMA, UMTC networks or any other messaging or communication facilities available.

### Accessing the Authentication Server

The various techniques described herein for monitoring a supply chain, including the authentication of goods, may be implemented by local or remote communication systems, including virtual private networks. In some embodiments, the communication system encompasses any suitable combination of networking hardware and protocols necessary to establish web-based communications between clients and the authentication server (authentication server) and application database server (authentication database server). In particular embodiments, secure connections are established using hypertext transfer protocol secure (https) connections or other suitable means. For example, the communication system may generally encompass the various telecommunications networks and service providers that collectively implement the Internet. The communication system may also include private networks such as local area networks (LANs) or wide area networks (WANs) as well as public or private wireless networks. For example, both a given client and the authentication server may be respectively provisioned within an enterprise having its own internal networks. In such an embodiment, the communication network may include the hardware (e.g., modems, routers, switches, load balancers, proxy servers, etc.) and software (e.g., protocol stacks, accounting software, firewall/security software, etc.) necessary to establish a networking link between the given client and the Internet as well as between the Internet and authentication server. In some embodiments, clients may communicate with the authentication server using a private network rather than the public Internet.

The methods of specific embodiments are suitable for any type of client capable of submitting service requests to an authentication server (web server associated with the authentication system) on behalf of a user or a requesting application. For example, a given client may include a suitable version of a web browser, or a plug-in module or other type of code module configured to execute as an extension to or within an execution environment provided by a web browser. Alternatively, a client may encompass an application such as a database application, media application, office application, or any other application that may make use of the services provided by the authentication system. In some embodiments, such an application may include sufficient protocol support (e.g., for a suitable version of https) for generating and processing web service requests without necessarily implementing full browser support for all types of web-based data. That is, a client may be an application configured to interact directly with the web server.

In various embodiments, a client may be configured to generate requests for web services according to a Representational State Transfer (REST)-style web services architecture, a document or message-based web services architecture, or other suitable web services architecture. In some embodiments, a client may be configured to provide access to web-based services to other applications in a manner that is transparent to those applications. For example, a client may be configured to integrate with an operating system to provide services in accordance with a suitable variant of the service model described herein. The operating system, however, may present a different service request interface to applications than those described herein.

Stationary devices can be used to access item data, including open and hidden keys and to communicate with the authentication server. Including traditional fixed phone network communications for the manual or verbal entry of data.

Portable wireless devices can also be used to communicate with the authentication server. Any device equipped with sufficient computational facility, memory and data storage and enabled to communicate with the authentication server using any standardized communication protocols can be used perform the disclosed methods. Useful portable wireless device are usually equipped with one or more of the following: an optical camera operating in the visible spectrum and potentially working in IR/UV mode, barcode reader (including standard, 2D or matrix readers), character scanner, key board or touch screen and may be enable for voice activation and input. Usually, any of the following devices may be employed to practice the methods, including a mobile phone, smart phone, personal digital assistant, or tablet. In particular embodiments, a mobile application software (mobile app or app) is download by the user onto a cell phone, smart phone, smart watch, tablet and other mobile device in order to communicate with the authentication server. Information to be transmitted to the server can be captured or inputted using a camera, barcode reader, key board, touch screen or microphone (for verbal data like a string of alphanumeric symbols).

Results from the authentication server can include confirming authenticity, questioning authenticity, warning that the item is not found in the database or that the item is counterfeit. The outputted results can be conveyed to the actors as data and optionally by visual, audio or tactile means where desirable.

### Management of the Authentication System

In some embodiments, the authentication system is hosted or managed by the top entity in a supply chain, i.e., the supplier, manufacturer or producer of the item. In other embodiments, the authentication system is hosted or managed by a third-party that is unrelated or unaffiliated with the provider of the item. Typically, the third-party charges the supplier of the item a fee for hosting or managing the monitoring system. Various fees structures are possible including a blanket fee for unlimited use, fees based on the number of keys and other identifying information stored in the authentication database, the length of time information is stored on the authentication database, the number of queries received for an item or product line, or the complexity of the distribution scheme. Similarly, retailers, wholesalers, and/or consumers can also be charged a blanket fee, monthly fee, or per-request fee to query the authentication database.

### Example Authentication Methods

The authentication methods of specific embodiments are applicable to a supply chain of any complexity and for a variety of purchasing and payment processing situations. For convenience, a simple supply chain consisting of four levels is illustrated in FIG. 1. In this example, a manufacturer of an item (Level 1) supplies a wholesaler (Level 2) that in turn supplies a retail store (Level 3) that subsequently offers the item for sale to a consumer (Level 4).

The following is a description of a general schema that is applied to the levels in the supply chain for registering items in an authentication database at an authentication server. In the example illustrated in FIG. 1, the general schema is applied to the levels 2-4. An authentication requester, e.g., a wholesaler, a merchant (e.g., retail shop, retail website, a private seller, etc.), customer, a payment processor or an issuing bank contacts the authentication server and sends transaction information including authentication information about the item (e.g., one or more open keys and optionally one or more hidden keys). The authentication server is contacted by any suitable means. For simplicity's sake and as a specific example, an authentication schema is describe using only one open key and optionally also one hidden key, but the authentication schema can also be based on any number of open and/or hidden keys. Other authentication schema can also be used.

In one scenario, the authentication requester sends an open key and optionally also a hidden key to the authentication server that is used to query the authentication database. If the open key is not in the database, a reply is sent to the authentication requester notifying the requester that item is not registered in the database or that it is counterfeit. If the open key is in the database, the authentication database is then queried using the hidden key. If the hidden key is not in the database, a reply is sent to the authentication requester notifying the requester that item is not registered in the database or that it is counterfeit.

### Counters

In some embodiments, a counter is stored in an authentication database and may be triggered or activated according to one or more recorded events or transactions, e.g., receipt of an item at a particular level of the supply chain, first authentication request, first sale, etc. Subsequent events or transactions advance the counter. For example, a counter can record the first and subsequent authentication requests for an item. Further, the counter can record the number of successful or unsuccessful authentication requests of an item. Information provided by counters can be useful in monitoring a supply chain. For example, determination of an item's authenticity can optionally be based on the number of times an authentication request was made. If the number of authentication requests (C in FIG. 4) is above a threshold number of authentication requests (N in FIG. 4) a reply can be sent to the authentication requester notifying the requester that the item was previously authenticated or that it is counterfeit. According to specific embodiments, a reply to particular levels of a supply chain (such as a retail customer) can be binary and indicate only whether an item is authenticated or not. Additional data generally is then sent to a supply chain monitor. If the number of authentication requests is below a threshold number of requests, a reply can be sent to the authentication requester notifying the requester that item is authentic. The threshold number of requests can vary with the type of good, with perishable goods having a lower threshold number than long-lived goods that are not consumed, e.g., a watch or piece of jewelry, that may be sold as a second-hand good, etc. In either case, the system provides a flexible authentication process, allowing for items that can be authenticated essentially only once (such as a bottle of wine or prescription drugs) and items that can be authenticated multiple times, such as jewelry.

### Timers and Elapsed Time

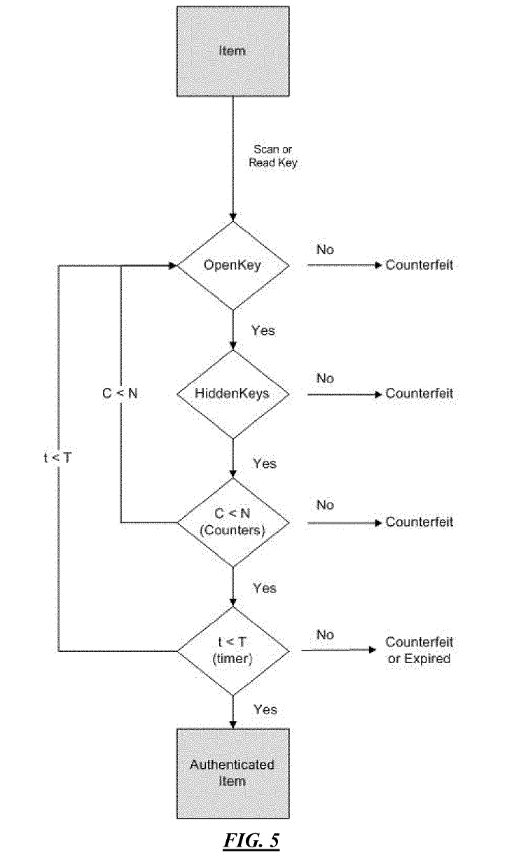

In other embodiments, a timer is stored in the authentication database and may be triggered or activated according to one or more recorded events or transactions, e.g., receipt of an item at a particular level of the supply chain, first authentication request, first sale, etc. Subsequent events or transactions may trigger additional timers. For example, a first timer may be triggered upon receipt of the first authentication request. Subsequent authentication requests can trigger additional timers. The amount of elapsed time that has occurred since the triggering of a timer can be used to determine the authenticity of an item. FIG. 5 illustrates an alternate embodiment that incorporates in addition to keys and a counter, a timer to record elapsed time. In the flowchart, after determining that the number of authentication requests is below a threshold number for a particular counter, the database is further queried to ascertain the amount of time that has elapsed since the first successful authentication of the item. If the elapsed time (t in FIG. 5) is shorter than the threshold time (T in FIG. 5) set in the database, a reply is sent to the authentication requester notifying the requester that item is authentic. Alternatively, if the elapsed time is longer than the threshold time in the database, a reply can be sent to the authentication requester notifying the requester optionally, of the long time delay, or that the item may be counterfeit.

For perishable items, timers and elapsed time can be used to determine if an item has exceeded its expiration date. For example, a timer can be activated when the perishable item is released to or received (authenticated) by a distributor. Subsequent authentications can cause the elapsed time from the first authentication to be checked with a threshold elapsed time value recorded in the authentication database. Reaching or exceeding a threshold elapsed time value indicates that the perishable good has expired. Requestors sending authentication requests after a perishable good has reached a threshold elapsed time setting can be sent a notification that the item has expired. Alternatively, requestors can be further instructed not to accept the good, how to return the good, how to properly dispose of the good, etc. as the situation may warrant.

For consumable items, a long elapsed time interval between authentication requests can indicate that the item was consumed and the container holding the item, for example, a bottle, was refiled and placed back into commerce. Accordingly, for consumable items, authentication requesters that send requests after a threshold elapsed time period can be sent notifications that the item is likely counterfeit. In additional embodiments, retailers and others in the supply chain can request the resetting of a timer in the authentication database, for example, in the case of when a customer returns or exchanges an item.

### Geographical Locations and Other Queries

Other queries of the authentication database can be performed following or in combination with the general schema illustrated above. (See FIG. 6.) For example, the geographical locations of the current and past requesters can be captured and stored in the authentication database and compared with each other and with recorded locations in the database of distributors, retail stores, distribution territories, etc. Distant geographical locations of the current and past requesters, particularly for a perishable or consumable item, can indicate that the current requester is trying to authenticate a counterfeit item. For instance, using a bottle of wine as an example, if the current requester is in Beijing and one or more past requesters were located in Shanghai, the wine may have been consumed in Shanghai and the bottle subsequently refilled and placed back into commerce. The current authentication requester could be sent a message alerting the current requester that the bottle of wine was previously authenticated and optionally, notifying the requester the past authentication locations.

In some embodiments, the geographical location of the sales territory, distribution territory, distributor locations or store locations are recorded in the authentication database. In further embodiments, the geographical location of each authentication requester is obtained and recorded in the authentication database. Receipt of authentication requests from outside of an authorized distribution territory may indicate the presence of gray market goods. Additionally, the geographical location of a requestor may help pinpoint the location of stores selling gray market or counterfeit goods. Collecting the geographical location of requestors and the time between requests can also be used to monitor the performance of shipping and transport companies used in a distribution chain.

In further embodiments, product storage conditions and other environmental records can be captured and recorded in the authentication database. For instance, with vaccines or other medical products that have strict temperature storage conditions, a temperature record of the product during transit to a particular distributor or at the distributor can be captured and stored in the authentication database. Authentication of the medical product at the distributor can include querying the authentication database for the temperature range of the medical product during transit. If the temperature during transit was within the accepted range and all other authentication conditions are met, the medical product can be declared authenticated and therefore, accepted by the distributor.

In other embodiments, product acceptance or release certificates can be captured and recorded in the authentication database. Authentication of goods can include querying the authentication database for the proof that the goods met acceptance or release criteria. Allowing downstream users the ability to instantly confirm that goods, ingredients, subcomponents, etc. met acceptance or release criteria provides a higher degree of transparency to the distribution system and the goods themselves than currently exists. Further, collected data can be used for audit or compliance purposes.

In further embodiments, IP addresses (IPA), media access control (MAC) addresses, phone numbers, email addresses, credit card number, or other payment option information, payment method identifier, or other identifying or contact information for authentication requesters are recorded in the authentication database and can be used to query the database. Capturing and recording the IPAs associated with the authentication requests can also be used to thwart cyber-attacks on the authentication webserver (authentication server) by allowing the blocking of particular IP addresses associated with repeated authorization requests. In some embodiments, the authentication database stores authentication requester ratings or opinions of items, reported problems related to the items or the authentication system. Pooled ratings and opinion data can be analyzed to determine product satisfaction and sentiment, or guide future product development or marketing and quality control efforts.

### Authentication Messages

In some embodiments, the messages to be conveyed to authentication requesters are stored in the authentication database or are retrieved or otherwise obtained from a database or website of a product's manufacturer. Possible messages include notification that the item is authentic, authenticity is questionable, the item was previously authenticated, authenticity cannot be confirmed, item is counterfeit, item has expired, item was recalled, item was stolen, retailer is not authorized and warranty will not be honored, etc.

### Monitoring for Counterfeit, Stolen or Gray Market Goods

In another aspect of specific embodiments, a method is provided to monitor a supply chain for the introduction of counterfeit, stolen or gray market goods. For example, an abnormal number of authentication requests for a particular item can indicate that the item has been counterfeited. For example, an expensive bottle of wine may have an open key that is a UPI. Receipt of multiple authentication requests using the same open key, particularly from different geographical locations and/or requests received in a short time span can indicate that the product line was counterfeited using that particular bottle as the example that was duplicated.

Further investigative information regarding the counterfeiting can be obtained by analyzing the information captured by the authentication database including the IPAs of the requesters and the geographically locations from which the requests originated. Additionally information could be received by sending messages to the requesters offering rewards for information regarding the purchased items including the location and the name of the store where the item was purchased. Requesters could also be offered rewards for sending photos of the counterfeit item or for sending the actual item to the manufacturer.

The presence of gray market goods can be indicated by the receipt of numerous authentication requests from geographical regions that are not covered by authorized distributors or where the number of authentication requests received from the region exceeds the number of authorized goods distributed to the region.

Similarly, the sale of stolen goods and the geographical location of the sales can be determined by the receipt of authentication request for goods that are listed in the authentication database as stolen. Warning messages can be sent to alert the requesters. Alternatively, notifications can be sent to the manufacturer, its investigators or the police. Investigators can discover the entities selling the stolen goods by offering the authentication requesters rewards for information regarding the sellers.

### Market Recalls, Product Warnings, Expirations

An authentication system that captures and stores the name or contact information of every authentication requester can be used to notify the requesters of future market recalls or other product warnings. Additionally, the authentication database can be updated to reflect newly issued market recalls or other product warnings so that when a new authentication request is received, the requester is sent a message notifying the requester of the issued marker recall or other product warning.

With perishable products, such as medicines or foodstuffs, the expiration date of the product can be entered and stored in the authentication database. When an authentication request is received after the expiration date, the requester can be sent a message notifying the request that the item has expired.

Additionally, notifications can also be sent to requestors reminding them of upcoming product expiration dates, maintenance schedules or maintenance requirements. For instance, a requestor that purchased a prescription drug may be sent a warning of the drug's expiration date and optionally, a list of locations where the expired drug may be brought for safe disposal. Similarly, a requestor that purchased a set of automobile tires may be sent a reminder to check the tire inflation pressure or to have the tires rotated. Requesters that purchased precision technical equipment could be sent reminders of calibration expiration dates and optionally, invitations to schedule a service visit to recalibrate the equipment. In some embodiments, additional instructions or reminders may be provided to a requester regarding proper delivery, use, storage, safety, disposal, or important information concerning the product.

### Market Studies, Marketing and Product Promotion

In some embodiments, identifying information from a requester is captured and stored in the authentication database along with associated information including request time, geographical location, and specific item connected with the request. Information associated with specific products, models, or product lines can be monitored and analyzed for various purposes. For example, information associated with authentication requests can be used for marketing purposes to track consumption patterns, including real-time usage of a product in a particular geographical location. Consumption could be calculated based on the known conversion rate of authentication requests to sales. Further, information about real-time consumption can be used to anticipate requests for additional product shipments or can indicate the gray market diversion of goods if the quantity of goods authenticated exceeds the amount sent to an authorized dealer or geographical location. Customer rewards in the form of coupons or discounts for future purchases, rebates, notification of future product promotions or sales can be sent to new and repeat authentication requestors. Shopping rewards can also include extra calling time or free music downloads to motivate consumers, particularly retail consumers, to authenticate an item using a smart phone.

### Knockoff Goods

According to further specific embodiments, the use of an authentication system prevents the consumer confusion in the market place in regards to “knockoff” goods. In addition to counterfeit goods that intend to exactly copy a company's trademarked brand name or logo, consumers often face knockoff goods that are designed to be similar enough in appearance to fool consumers into purchasing the knockoff goods. For example, in various niche market, discount and/or dollar stores, in addition to authentic “Arm & Hammer” baking soda, consumers are often presented with something such as an “Arm & Hatchet” baking soda in a similarly sized and colored box that imitates the look of an authentic box without exactly copying the brand name or logo. If consumers are educated to look for and use an open key, typically presented with a seal or other identifier, to authenticate an item, the instances of consumer confusion and hence, the sale of knockoff goods is decreased.

### Digital Life of an Item

In some embodiments, the authentication system allows for the construction and maintenance of a “digital life,” a complete history of an item from the time of its creation or manufacture, through the supply chain to a retail customer and to any after-market purchasers. With luxury goods and other expensive or long-lived products, a digital life history of the product can enhance the value of the product by providing a secure means of authenticating the good. In some embodiments, the authentication system can be used to transfer the registration or ownership information associated with the good. In further embodiments, the purchase of a used item or luxury item can be predicated on the successful authentication of the item. In some embodiments, this predication can be incorporated into a payment processing system, such as a credit card purchase authorization.

### E-Commerce

In some embodiments, the authentication database is integrated with, linked to, or otherwise accessed by an e-commerce website including an auction website, e.g., Ebay. In further embodiments, the listing process to place an item for sale on the website includes a check of the item's authenticity using the authentication database. If an item was not previously registered with the authentication database, the seller may be required to register the item before listing of the item on the website can be completed. If the item was previously registered with the authentication database, for authentication database may offer or require an update to the existing information about the item on the authentication database. In additional embodiments, only authenticated items can be listed for sale on the e-commerce website.

In further embodiments, items listed on an e-commerce website display a certification, seal or other mark that confirms the authenticity of the item and optionally, displays the digital life of the item or warranty information. Alternately, the listing may include a link to the authentication database, thereby allowing a potential purchaser to confirm the item's authenticity and optionally, examine the item's digital life and warranty information.

### Escrow System

In additional embodiments, the authentication system is integrated with or linked to a payment processing system to form an escrow system. With the escrow system, only authenticated items can be bought and sold. For an item that was previously registered with or authenticated by the authentication database, ownership of the item is transferred from the seller to an escrow account prior to or at the time of the transaction. The buyer would place funds, a security interest, or a credit guarantee into the escrow account or authorize payment from a credit card, debit card, or other payment system vehicle, e.g., PayPal, Apple Pay, cryptocurrency, etc., to the escrow account prior to or at the time of the transaction. Upon buyer initiation, the sales transaction occurs with ownership of the item transferred from the escrow account to the buyer with the authentication database updated to reflect the change in ownership. Contemporaneously, the funds held in the escrow account are transferred to the seller's account.

In some embodiments, the escrow account is established in the authentication database. In further embodiments, the escrow account is established with a third-party, for instance, an escrow service provider. In other embodiments, the escrow account is established with a bank, credit union or other financial institution; or a commercial institution including an e-commerce website, auction website or other sales website. In further embodiments, the financial institution, commercial institution or e-commerce site has a pre-existing relationship with the buyer or seller.

In additional embodiments, the ownership transfer occurs within the authentication database, while the funds transfer occur at a financial, commercial, e-commerce or third-party site. For example, the owner of an item lists the item for auction on an on-line auction website like EBay and as part of the listing process, ownership of the item is transferred in the authentication database to the ownership escrow account. Auction bidders are pre-qualified, i.e., have approved credit cards, debit cards, PayPal accounts, etc. that have sufficient funds available to cover the expected cost of the item and optionally, the bidders are registered with the auction website. For example, an auction is held for a Couch purse wherein the historical auction price for same model of purse is in the range of $150-$200 and the shipping cost has a historical range of $25-$35. Pre-qualified bidders have available credit limits or account balances (PayPal, etc,) in excess of the historical price and shipping ranges, e.g., at least $300. At the conclusion of the auction, the registration of the item is transferred in the authentication database to the winning bidder. Contemporaneously, a payment request is made to the buyer's credit card, debit card, PayPal account, etc. with the received funds placed into the seller's account. Optionally, the winner bidder can opt out of registering ownership with the authentication database.

In a “Buy it now” or other non-auction situation, the listing of an item at the e-commerce site is predicated on successful authentication of the item. Optionally, ownership of the item can also be transferred to an escrow account as part of the listing process. When a buyer decides to purchase the listed item, the transfer of ownership from the escrow account to the buyer occurs contemporaneously in the authentication database with the request for payment made to the buyer's credit card, debit card, PayPal account or other payment vehicle. Received funds are then placed into the seller's account.

### Authentication—Payment Processing System

In some aspects of specific embodiments, an authentication system is integrated with or linked to a payment processing system. Using this system requires an item to first be successfully authenticated before payment of the item is approved. Requiring the authentication of an item before authorizing payment can prevent the unwitting purchase of counterfeit, knockoff, stolen, expired, gray market or otherwise unauthorized goods. In other embodiments, successful authentication of an item is required prior to or contemporaneous with the submission of an invoice or other request for payment. For example, as a method to reduce the market for stolen car parts and ensure the safety of repaired cars, insurance companies may only pay automobile repair shops for auto parts that are successfully authenticated prior to installation. The submission of an invoice may include proof of previous authentication or a link to an authentication database where the payer can confirm previous authentication of items.

In some embodiments, the authentication-payment processing system is a fixed or store-based payment processing system, for example, using point-of-sale terminals. In alternate embodiments, the authentication-payment processing system operates on mobile devices or through a combination of fixed and mobile payment processing systems. In further embodiments, the authentication-payment processing system is engaged by a customer through a downloadable, mobile application or through a link to a website.

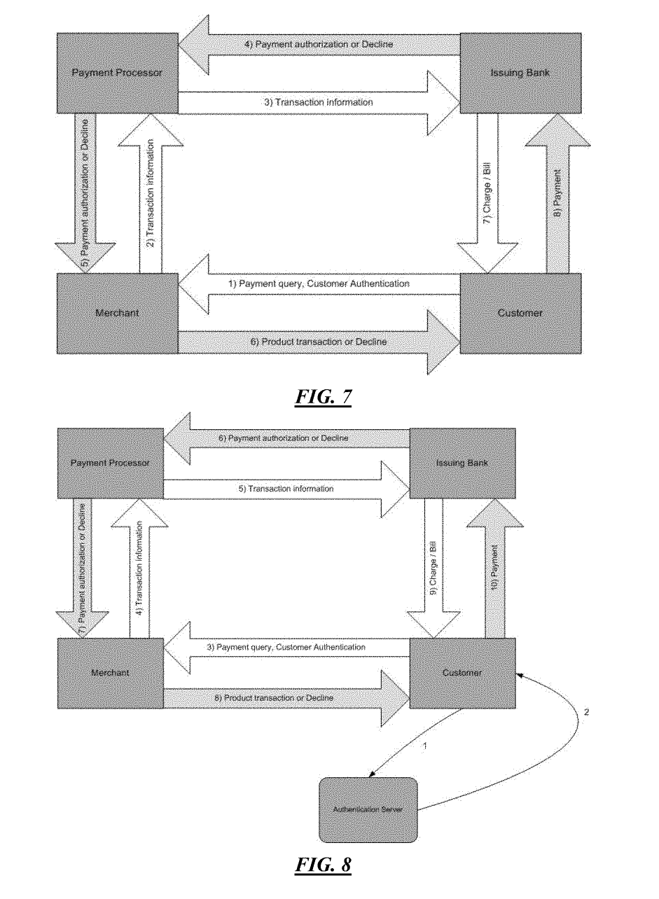

The following flowcharts demonstrate various embodiments of an authentication—payment processing system. For simplicity, the card networks are not shown in the flowcharts. For reference, FIG. 7 illustrates a prior art payment processing scheme currently used for credit cards, debit cards, prepaid cards and mobile payment apps. This payment processing scheme lacks a product authentication step and thereby allows a customer to unwittingly purchase counterfeit, expired, recalled or stolen goods.

In Step 1 of the payment processing scheme illustrated in FIG. 7, a payment query is made in which a Customer tenders to a Merchant the item to be bought and a credit card, debit card, gift card, mobile payment app or other payment vehicle. Frequently, customer identification (Customer Authentication) and customer payment authorization, e.g., PIN code, are also required. The Merchant in Step 2 forwards to a Payment Processor (Acquiring Bank or processor for Acquiring Bank) the transaction information that typically includes a sales authorization request, Customer's identification, Merchant ID, Merchant Categorization Code (MCC), dollar amount of purchase and item identification. The Payment Processor in Step 3 then forwards the transaction information via a card network to an Issuing Bank for payment approval. Upon examination of specific acceptance criteria that typically includes the Customer's credit limit, credit risk, payment history and item's price, the Issuing Bank will authorize or decline the transaction. The Issuing Bank then sends the payment authorization decision via the card network to the Payment Processor in Step 4. If the payment is approved, the Issuing Bank assigns and transmits an authorization code to the Payment Processor. The Payment Processor forwards the payment authorization decision to the Merchant Step 5, including the authorization code if warranted. Subsequently, in Step 6, if the payment is approved, the Customer receives the item from the Merchant, typically after signing a receipt or confirming the transaction on a terminal, mobile app or website. Later, the Issuing Bank will send a billing statement to the Customer requesting payment for the transaction and any other transactions that occurred during the billing cycle in Step 7. The Customer sends payment to the Issuing Bank in Step 8. Alternatively, if payment authorization was declined by the Issuing Bank, the Payment Processor forwards the rejection decision to the Merchant in Step 5. Next, the Merchant notifies the Customer of the Issuing Bank's decision not to allow the purchase in Step 6.

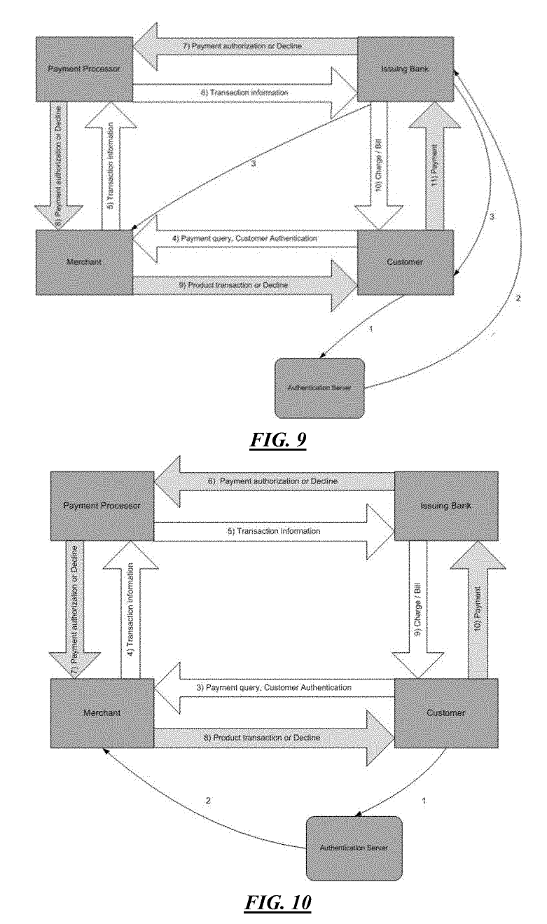

FIG. 8 illustrates one method of incorporating a product authentication step into the payment processing scheme. In this example, a Customer sends a query request to an authentication server that queries an authentication database (Step 1). The query request typically includes at least one unique product identifier, for example an open key, serial number or hidden key. The query request can be sent through an authentication mobile app or indirectly through a mobile payment app that is enabled to send a query request to the authentication server. The authentication server queries the authentication database to see if the unique product identifier sent by the Customer is recorded in the authentication database and associated with the product. The query result is then sent to the Customer (Step 2) typically through the authentication mobile app or through the mobile payment app. The query result includes notification regarding the likelihood of product authenticity. If the query of the authentication database determines that the product is authentic, the customer can elect to proceed with the purchase following conventional payment processing Steps 3-10, if desired, for example by tendering the item and payment vehicle to Merchant, including, for example, pressing a proceed button on the mobile payment app. If the query of the authentication database determines that the item was never recorded in the authentication database, the Customer can receive notification that the product is counterfeit and can be cautioned not to purchase the item. In the case of a mobile payment app, the app may optionally, prevent payment for the item. Additionally, the notification may request the Customer to call the manufacturer's customer service line to provide information regarding the seller of the counterfeit item or to receive further information or help in purchasing an authentic item.

FIG. 9 illustrates an alternate method of incorporating an authentication step into the payment processing scheme. In this example, a Customer sends a query request to an authentication server that queries an authentication database (Step 1). The query request can be sent through an authentication mobile app or indirectly through a mobile payment app that is enabled to send a query request to the authentication server. The query result is then sent to the Issuing Bank either directly, through the authentication mobile app or the mobile payment app. (Step 2) Based on specific acceptance criteria that may include in addition to the likelihood of the item's authenticity, the price of the item, the spending limit or profile of the customer, the Issuing Bank can preliminarily accept or reject the transaction. The Issuing Bank can notify the Customer and optionally, the Merchant of the authentication result and/or the preliminary acceptance or rejection of the transaction (Step 3). Notification can be made through the mobile payment app or authentication mobile app and may optionally be relayed through the authentication server. Preliminary acceptance by the Issuing Bank can initiate the conventional payment processing cycle, Steps 4-11.

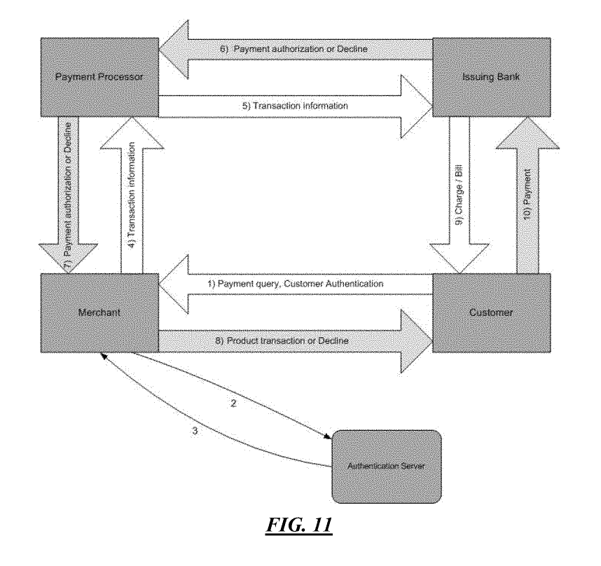

FIG. 10 illustrates an alternate method of incorporating an authentication step into the payment processing scheme. In this example, a Customer sends a query request to an authentication server that queries an authentication database (Step 1). The query request can be sent through an authentication mobile app or indirectly through a mobile payment app that is enabled to send a query request to the authentication server. The query result is then sent to a Merchant (Step 2). If the item is authentic, the merchant can accept the Customer's tender of the item and payment vehicle to initiate the conventional payment processing cycle (Steps 3-10).

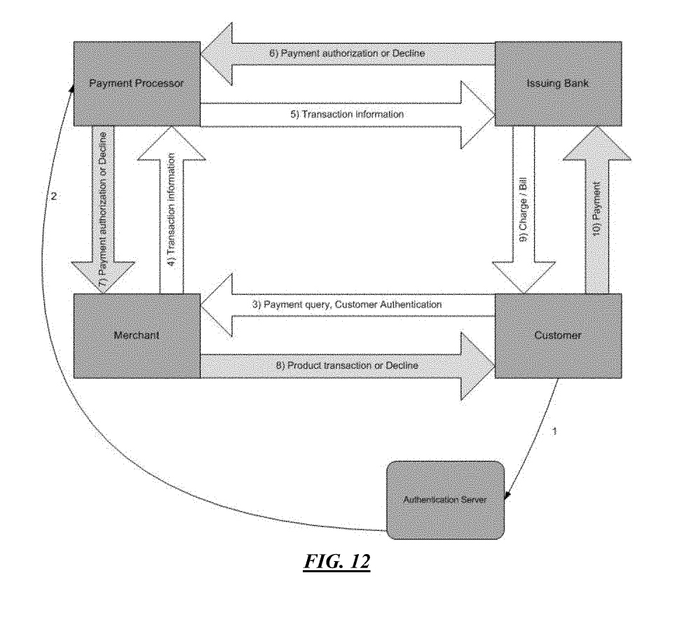

FIG. 11 illustrates an alternate method of incorporating an authentication step into the payment processing scheme. In this example, a Customer tenders to a Merchant the item to be bought and a payment vehicle, e.g., credit card, debit card, gift card, mobile payment app, etc. (Step 1). The Merchant sends a query request to an authentication server that queries an authentication database (Step 2). The query request can be sent through a Point of Sales system, gateway, internet, or mobile app. The query result is then sent to the Merchant (Step 3). If the item is authentic, the Merchant can proceed with the conventional payment processing cycle (Steps 4-10).

FIG. 12 illustrates an additional method of incorporating an authentication step into the payment processing scheme. In this example, a Customer sends a query request to an authentication server through an authentication mobile app or indirectly through a mobile payment app that is enabled to send queries to the authentication server (Step 1). The query result is then sent to a Payment Processor (Step 2). The query result can be sent through the authentication mobile app, the mobile payment app or directly from the authentication server. The Customer tenders item and payment to the Merchant (Step 3). The Merchant forwards transaction information to Payment Processor (Step 4). The Payment Processor matches the authentication results with the transaction information received from the Merchant. Based on specific acceptance criteria that may include the item's price, in addition to the likelihood of the item's authenticity, the payment Processor can reject the transaction or preliminarily accept the transaction. The Payment Processor can optionally, notify the Customer and/or Merchant of the preliminary acceptance or rejection of the transaction. Acceptance of the purchase by the Payment Processor allows the conventional payment processing cycle (Steps 5-11) to proceed.

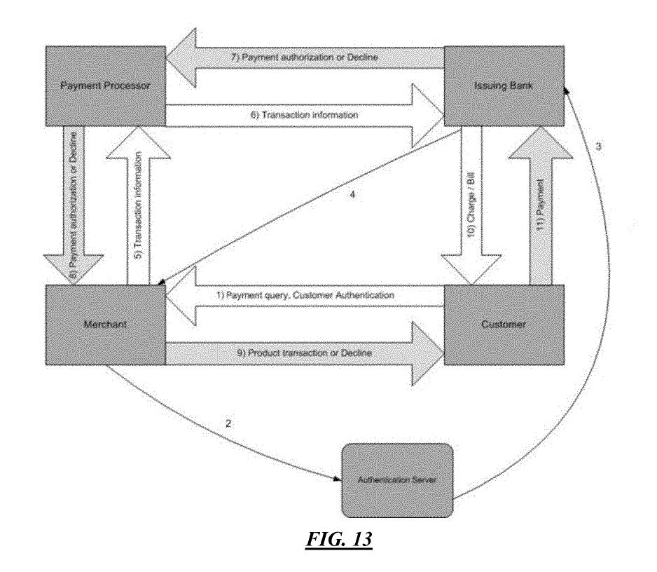

FIG. 13 illustrates a further method of incorporating an authentication step into the payment processing scheme. In this example, a Merchant sends a query request to the authentication server (Step 2). The query result is then sent to an Issuing Bank (Step 3). Based on specific acceptance criteria that may include the likelihood of the item's authenticity and the price of the item, the Issuing Bank can preliminarily accept or reject the transaction. The Issuing Bank then notifies the Merchant of the authentication result and/or preliminary acceptance or rejection of the transaction (Step 4). Notification can be through a point of sale payment processing system, mobile app or website. The initial acceptance of the transaction by the Issuing Bank is required for the conventional payment processing cycle to proceed (Steps 5-11).

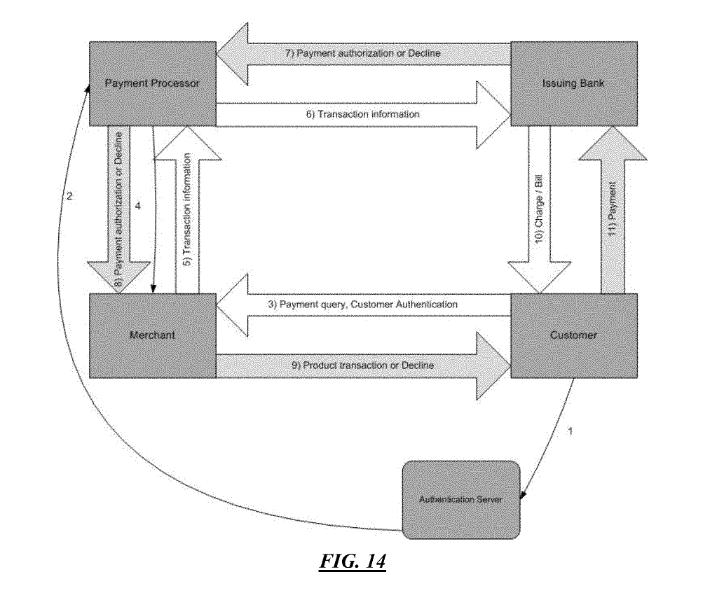

FIG. 14 illustrates another method of incorporating an authentication step into the payment processing scheme. In this example, a Merchant sends a query request to the authentication server (Step 2). The query result is then sent to a Payment Processor (Step 3). Based on specific acceptance criteria that may include the item's price, in addition to the likelihood of the item's authenticity, the Payment Processor can reject or preliminarily accept the transaction. The Payment Processor, notifies the Merchant of the preliminary acceptance or rejection of the transaction and/or authentication results (Step 4). The preliminary acceptance of the transaction by the Payment Processor is required for the conventional payment processing cycle to proceed (Steps 5-11). The Payment Processor can additionally notify the Merchant of rejection of the transaction.

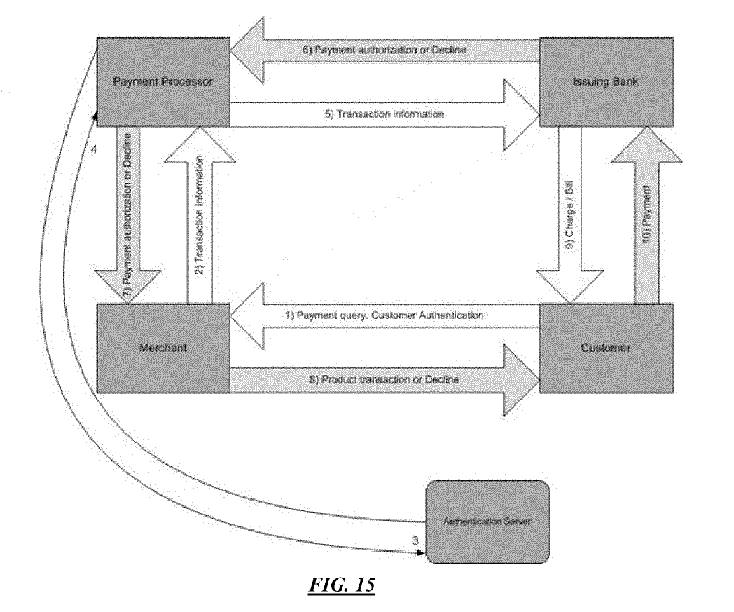

FIG. 15 illustrates an alternate method of incorporating an authentication step into the payment processing scheme. In this example, included in the transaction information sent by Merchant to Payment Processor in Step 2 is at least one unique product identifier, for example an open key or serial number. The Payment Processor sends a query request to the authentication server (Step 3). The query result is then sent to the Payment Processor (Step 4). Based on specific acceptance criteria that may include in addition to the likelihood of the item's authenticity, the price of the item, the Payment Processor can reject or preliminarily accept the transaction. The Payment Processor can optionally, notify the Merchant of the preliminary acceptance of the transaction and/or authentication results. The preliminary acceptance of the transaction by the Payment Processor is required for the conventional payment processing cycle to proceed (Steps 5-10). The Payment Processor can additionally notify the Merchant of rejection of the transaction. Notification can be through a point of sale payment processing system.

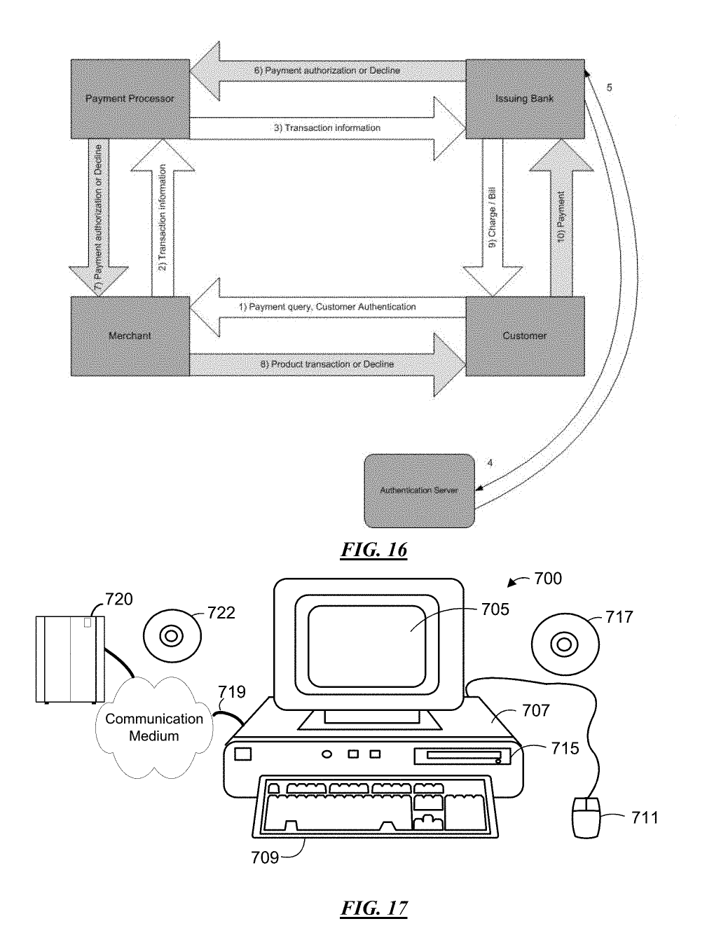

FIG. 16 illustrates a further method of incorporating an authentication step into the payment processing scheme. In this example, included in the transaction information sent by Merchant to Payment Processor in Step 2 is at least one unique product identifier, for example an open key or serial number. Following the relaying of the transaction information from the Payment Processor to the Issuing Bank in Step 3, the Issuing Bank sends a query request to the authentication server (Step 4). The query result is then sent to the Issuing Bank (Step 5). Based on specific acceptance criteria that may include in addition to the likelihood of the item's authenticity, the price of the item, the spending limit or profile of the customer, the issuing bank can accept or reject the transaction. Acceptance of the transaction allows the conventional payment processing cycle to proceed (Steps 6-10). Optionally, notification of authentication results can be relayed through the conventional payment processing route, i.e., (Steps 6-8), for example, using a point of sale payment processing system, or through a mobile payment app, if used or directly to the customer, for example a text message.

In some embodiments, the authentication request and query is performed behind the scenes, without the customer's knowledge or participation beyond tendering payment to a merchant or other seller. In further embodiments, the authentication-payment processing system is used for the purchase of services from authorized service providers. For example, a professional organization may certify and/or authorize practioners to provide an approved form of therapy. Payment for therapy may be predicated on the practioner being authorized by the organization to provide the particular form of therapy.

### Payment Authentication Options

As described above, authentication for payment purposes can be initiated by various actors in a payment transaction. As further specific examples, the following steps can be used to accomplish item authentication for payment processing. Note that in specific embodiments, two or more of the examples below can be used together. For example, an authentication server can be configured to respond to an authentication request from any actor in the payment process and to reply to any actor, as specified by the authentication request.

TABLE 1
Payment Processor request to Authentication Server

| | |
|---|---|
| 1. | Manufacturer registers an item with the authentication database |
| | including at least one key associated with the item. |
| 2. | Item placed into the stream of commerce, e.g., item is distributed and |
| | ends up in a retail store. |
| 3. | Customer selects item and brings it to Merchant. |
| 4. | Merchant scans item for price and key. |
| 5. | Customer indicates or presents payment method, e.g., credit card, |
| | pre-paid card, Apple Pay, Google Wallet, etc. |
| 6. | Payment method information and key are sent to payment processor |
| | for approval. |
| 7. | Payment processor receives request and checks its databases for |
| | Customer's account information (credit limit, credit risk, payment |
| | history, etc.) and sends a query request to the authentication server. |
| | The server queries the authentication database to see if the key is |
| | recorded in the database and associated with the item to be purchased. |
| 8. | If the key is in the authentication database and is validly associated |
| | with the item to be purchased (authenticated), an authentication |
| | notification is sent to the payment processor. The payment processor |
| | then forwards the payment method information, item information, |
| | price, merchant identification to the issuing bank for approval. |
| 9. | If the purchase is approved by the issuing bank then payment |
| | authorization is sent to the payment processor and then forwarded |
| | to the merchant. |
| 10. | Optionally, the authentication database can be updated with |
| | Customer's name and contact information. This can be used for |
| | marketing purposes, market research, recall notices, etc. |
| 11. | Optionally, multi-factorial authentication is used to authenticate the |
| | item, including, date, time and geographical location of requestor, |
| | number of authentication requests received, time since first |
| | authentication request was received, etc. |
| 12. | Optionally, the date, time, geographical location of the purchase |
| | request is recorded. This information can be used to monitor the |
| | supply chain, identify locations where counterfeit goods may be |
| | entering the market, and for marketing purposes. |

TABLE 2
Payment and Item Verification Coupled
with Warranty Registration Schema

| | |
|---|---|
| 1. | Manufacturer registers an item with the authentication database |
| | including at least one key associated with the item and |
| | warranty information (placeholder for owner or by |
| | default lists Manufacture as initial owner). |
| 2. | Item placed into the stream of commerce, e.g., item is distributed |
| | and ends up in a retail store. |
| 3. | Customer selects item and brings it to the Merchant. |
| 4. | Merchant scans item for price and key. |
| 5. | Customer indicates or presents payment method, e.g., credit card, |
| | pre-paid card, Apple Pay, Google Wallet, etc. |
| 6. | Payment method information and key are sent to payment processor |
| | for approval. |
| 7. | Payment processor receives request and checks its databases for |
| | Customer's account information (credit limit, credit risk, payment |
| | history, etc.) and sends a query request to the authentication server. |
| | The server queries the authentication database to see if the key is |
| | recorded in the database and associated with the item to be purchased. |
| 8. | If the key is in the authentication database and is validly associated |
| | with the item to be purchased (authenticated), an authentication |
| | notification is sent to the payment processor. The payment processor |
| | then forwards the payment method information, item information, |
| | price, merchant identification to the issuing bank for approval. |
| 9. | If the purchase is approved by the issuing bank then payment |
| | authorization is sent to the payment processor and then forwarded |
| | to the merchant. |
| 10. | Authorization of payment triggers a request by the payment processor |
| | to the authentication server to update the authentication database with |
| | the Customer's name and contact information and to transfer the |
| | warranty for the item, typically from the name of the Manufacturer to |
| | the Customer. |
| 11. | Optionally, Customer and/or Manufacturer are notified of the change |
| | in the warranty information. |
| 12. | Optionally, Customer's information can be used for marketing |
| | purposes, market research, recall notices, etc. |
| 13. | Optionally, multi-factorial authentication is used to authenticate the |
| | item, including, date, time and geographical location of requestor, |
| | number of authentication requests received, time since first |
| | authentication request was received, etc. |
| 14. | Optionally, the date, time, geographical location of the purchase |
| | request is recorded. This information can be used to monitor the |
| | supply chain, identify locations where counterfeit goods may be |
| | entering the market, and for marketing purposes. |

TABLE 3
Authentication Server Contacts Merchant For Key

| | |
|---|---|
| 1. | Manufacturer registers an item with the authentication database |
| | including at least one key associated with the item. |
| 2. | Item placed into the stream of commerce, e.g., item is distributed |
| | and ends up in a retail store. |
| 3. | Customer selects item and brings it to Merchant. |
| 4. | Merchant scans item for price. |
| 5. | Customer presents or indicates payment method. |
| 6. | Payment method information is sent to payment processor. |
| 7. | Payment processor receives request and sends query request to |
| | authentication server. |
| 8. | Authentication server sends request to Merchant to provide |
| | the item's key. Request may disclose the location of the key. |
| 9. | Merchant sends the key to the authentication server. |
| 10. | Authentication server queries authentication database for the |
| | key. If the key is recorded in the authentication database and |
| | is validly associated with the item to be purchased, an |
| | authentication notification is sent to the payment processor. |
| 11. | Payment processor then contacts issuing bank for payment |
| | authorization. |
| 12. | If the purchase is approved by the issuing bank then payment |
| | authorization is sent to the payment processor and then forwarded |
| | to the merchant. |
| 13. | Optionally, the authentication database can be updated with |
| | Customer's name and contact information. This can be used for |
| | marketing purposes, market research, recall notices, etc. |
| 14. | Optionally, multi-factorial authentication is used to authenticate the |
| | item, including, date, time and geographical location of requestor, |
| | number of authentication requests received, time since first |
| | authentication request was received, etc. |
| 15. | Optionally, the date, time, geographical location of the purchase |
| | request is recorded. This information can be used to monitor the |
| | supply chain, identify locations where counterfeit goods may be |
| | entering the market, and for marketing purposes. |

TABLE 4
Payment and Item Verification, Coupled
with Warranty Registration

| | |
|---|---|
| 1. | Manufacturer registers an item with the authentication database |
| | including at least one key associated with each item and |
| | warranty information (placeholder for owner or default |
| | lists Manufacture as initial owner). |
| 2. | Item placed into the stream of commerce e.g., item is distributed |
| | and ends up in a retail store. |
| 3. | Customer selects item and brings it to Merchant. |
| 4. | Merchant scans item for price. |
| 5. | Customer presents or indicates payment method. |
| 6. | Payment method information is sent to payment processor |
| | for approval. |
| 7. | Payment processor receives request and checks its databases for |
| | Customer's account information (credit limit, credit risk, payment |
| | history, etc.) and sends query request to authentication server. |
| 8. | Authentication server sends request to Merchant to provide |
| | the item's key. Request may disclose the location of the key. |
| | Query can be sent through payment processor. |
| 9. | Merchant sends key to the authentication server. Answer can |
| | be sent through payment processor. |
| 10. | The authentication server queries the authentication database for the |
| | key. If the key is in the authentication database and is validly |
| | associated with the item to be purchased, an approval message |
| | is sent to the payment processor. |
| 11. | If Customer is approved based on the consumer's financial account |
| | status and the item is authenticated by the authentication database, |
| | then the payment processors sends payment approval to the store and |
| | sends a request to the authentication database associate to update the |
| | warranty information with the name and contact information |
| | associated with Customer. |
| 12. | Optionally, Customer and/or manufacturer are notified of the change |
| | in the warranty information. |
| 13. | Optionally, the authentication database can be updated with |
| | Customer's name and contact information. This can be used for |
| | marketing purposes, market research, recall notices, etc. |
| 14. | Optionally, multi-factorial authentication is used to authenticate the |
| | item, including, date, time and geographical location of requestor, |
| | number of authentication requests received, time since first |
| | authentication request was received, etc. |

TABLE 5
Expert Authentication of Second Hand Item
and Payment Schema for use with a Website

| | |
|---|---|
| 1. | Seller brings item to an approved Expert, typically bonded or |
| | certified, for authentication and optionally grading, i.e., |
| | extent of wear, etc. |
| 2. | Expert registers the item with the authentication database and is |
| | assigned a key from the database that may be affixed or otherwise |
| | associated with the item. |
| 3. | Seller or Expert lists the good for sale via a e-commerce website, |
| | e.g., Ebay, as an authenticated item. |
| 4. | Customer selects item from website and pays for it in the normal |
| | way, e.g., credit card, PayPal, etc. |
| 5. | Upon payment approval, the authentication database is updated with |
| | Customer's name and contact information to reflect the change in |
| | ownership, thereby extending and modifying the digital life of the |
| | item. |
| 6. | Optionally, a warranty can also be transferred to Customer. |
| 7. | Optionally, a confirmation of the update to the authentication |
| | database can be sent to Customer and/or Seller. |
| 8. | Optionally, Customer information can be used for marketing |
| | purposes, market research, recall notices, etc. |

### Embodiment(s) in a Programmed Information Systems

For simplicity, the card network is not shown in the flowchart. FIG. 17 is a block diagram showing a representative example logic device in which various aspects of the present invention may be embodied. As will be understood to practitioners in the art from the teachings provided herein, specific embodiments can be implemented in hardware and/or software. In some embodiments, different aspects can be implemented in either client-side logic or server-side logic. As will be understood in the art, the invention or components thereof may be embodied in a fixed media program component containing logic instructions and/or data that when loaded into an appropriately configured computing device cause that device to perform according to specific embodiments. As will be understood in the art, a fixed media containing logic instructions may be delivered to a user on a fixed media for physically loading into a user's computer or a fixed media containing logic instructions may reside on a remote server that a user accesses through a communication medium in order to download a program component. Specific embodiments also may be embodied in whole or in part within the circuitry of an application specific integrated circuit (ASIC) or a programmable logic device (PLD). In such a case, specific embodiments may be embodied in a computer understandable descriptor language, which may be used to create an ASIC, or PLD that operates as herein described.

FIG. 17 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of specific embodiments as described herein. One type of logical apparatus that may embody the invention according to specific embodiments is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc.. In specific embodiments, the invention may be embodied in whole or in part as software recorded on this fixed media. Communication port 719 may also be used to initially receive instructions that are used to program such a system and may represent any type of communication connection.

### Conclusion

In addition to other embodiments described herein, specific embodiments may be embodied as one or more information devices or systems for collecting, storing, and communicating data as described herein and for performing data analysis, data communications, and transmissions of signals and output as described herein. It will be recognized in the art that many different and varying devices and systems can be specifically configured to operate as described herein. The information devices or computers described herein may be any kind of information handling device or system capable of being specifically configured as described herein. The information devices or computers described herein may include one or more logic processors, such as processors developed or manufactured by Qualcomm, Nvidia, Samsung, Apple, Motorola, or any other commercially available or proprietary logic processors. The information devices or computers described herein may include one or more operating systems or associated system or support logic modules, such as Android, Linux, iPhoneOS, Windows, AppleOS, Chrome, etc. Logic instructions or programs may be resident on a storage medium, e.g., any electronic, magnetic, optical, or other digital storage device, which is accessible to a processor via any hardwired or wireless interface. While a storage media is tangible, it may be removable and at times located some distance from in information device and accessed over a communications channel. Thus, logic instructions embodying specific implementations can reside on a hard drive, non-volatile electronic memory, a removable disk or media such as a memory stick or SD media, wired or wireless network based or Bluetooth based Network Attached Storage (NAS), or any such media accessed in a “cloud” computing environment or over a network, such as the Internet. Thus, programs may be run over a network, for example, with a server or other machine sending signals to the local machine, which allows the local machine to carry out the operations described herein. Therefore, specific embodiments involve a stored computer program product or stored logic instruction product for configuring systems and devices to operate as described herein. The product includes a tangible media embodying stored computer usable program code or instructions that when used to configure a system or device directs the system or device to operate as described herein. Various specific embodiments provide methods and/or systems and/or devices for operating as described herein that can be implemented by specifically configuring an device or system, such as a commercial or laboratory or diagnostic or production information system, a portable or semi-portable or fixed personal information system, a workstation, using one or more suitable programming languages such as Java, C++, C#, Cobol, C, Pascal, Fortran, PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

It is well known in the art that systems and methods such as described herein can include a variety of different components and different functions in a modular fashion. Different example specific embodiments and implementations can include different mixtures of elements and functions and may group various functions as parts of various elements. For purposes of clarity, embodiments of the invention are described in terms of systems that include many different innovative components and innovative combinations of innovative components and known components. No inference should be taken to limit the claimed invention to combinations containing all of the innovative components listed in any illustrative embodiment in this specification. Reference herein to an embodiment having a particular feature and reference elsewhere herein to another embodiment having a different feature does not exclude from this disclosure embodiments which have both features or all features described herein, unless such exclusion is expressly stated herein.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Thus, the general structure and techniques, and more specific embodiments that can be used to effect different ways of carrying out the more general goals are described herein. Although only a few embodiments have been disclosed in detail herein, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The inventors intend that only those claims which use the words “means for” are intended to be interpreted under 35 USC 112, sixth paragraph. Moreover, no limitations from the specification are intended to be read into any claims, unless those limitations are expressly included in the claims. All references, publications, patents, and patent applications cited herein are hereby incorporated by reference in their entirety for all purposes.

Although particular embodiments are expressly illustrated and described herein as processes, as configured media, or as systems, it will be appreciated that discussion of one type of embodiment also generally extends to other embodiment types. It does not follow that limitations from one embodiment are necessarily read into another. In particular, processes are not necessarily limited to the data structures and arrangements presented while discussing systems or manufactures such as configured memories.

1-32. (canceled)

33. A method of effecting payment for an item, the method comprising:
(a)verifying the authenticity of the item; and
(b)authorizing payment for the item, if the item is authentic,
wherein verifying the authenticity of the item comprises querying a database and wherein authenticity is confirmed if a key associated with the item is present in the database. cancel

34. (canceled)

35. The method of claim 33, wherein the database comprises a plurality of keys that are associated with a plurality of items and authenticity is confirmed if a key associated with the item is recorded in the database.

36-42. (canceled)

43. The method of claim 33 wherein the verifying comprises:
one or more users using a payment or authentication application to purchase or sell an item causes a authentication query for that item to be sent to an authentication server;
the one or more users receives the authentication results from the authentication server; and
the one or more users decides whether or not to proceed with the purchase based on the authentication results.

44. The method of claim 43 wherein the one or more users comprises one or more users selected from the group:
one or more issuing banks;
one or more payment processors;
one or more buyers;
one or more sellers;
one or more merchants.

45-46. (canceled)

47. The method of claim 33 further wherein:
completing a purchase of an item requires action by a plurality of actors;
an action by at least one actor causes an authentication query to be sent an authentication server;
the authentication server sends a response to at least one of the actors; and
at least one actor receiving an authentication response makes a decision regarding whether or not to complete the purchase based on the query response.

48-49. (canceled)

50. The method of claim 47 further wherein:
the plurality of actors comprises one or more of a customer, a merchant, a payment processor, and an issuing bank.

51. The method of claim 47 further wherein:
an actor causing the authentication request is different from the actor receiving the authentication results.

52. The method of claim 47 further wherein:
one or more actors are not aware of the authentication request or the authentication results.

53-55. (canceled)

56. A method of authorizing payments for one or more items comprising:
configuring an authentication database in an authentication server, said authentication server including at least one processor, at least one memory, and at least one communication interface,
wherein the authentication database is configured to store data values associated with the one or more items;
configuring the authentication server to store values regarding items and their authentication status in the authentication database:
receiving authentication requests for an item from one or more actors in a payment transaction;
using data from the authentication requests and stored data values to determine if an item is authentic; and
transmitting one or more authentication results to the authentication requester or payment requester.

57. The method of claim 56 further comprising:
receiving authentication requests for an item during a payment transaction; and
processing the payment transaction in accordance with whether or not the item is authenticated.

58. The method of claim 56 further comprising:
sending the authentication request and receiving a valid authentication result prior to completing one or more steps of a payment or buying transaction.

59. The method of claim 56 further comprising:
requiring an authentication prior to completing a credit card or other non-cash transaction.

60. The method of claim 56 further comprising:
holding all or part of a payment in escrow until an authentication is received.

61. The method of claim 56 further comprising:
update the authentication database to reflect the request; and
optionally transmit authentication data and/or additional data to a supply chain monitor.

62. The method of claim 56 further wherein data values associated with an item comprise:
at least one stored open key, e.g., a unique product identifier.

63. The method of claim 62 wherein data values associated with an item further comprise:
data regarding the item stored at the database when the open key was initially stored;
data regarding the item stored at the database as a result of additional data received at the database;
data regarding one or more previous monitoring or authentication requests; and
data regarding time of request, location from which request was received, or other data regarding the request that is generally independent of the item or open key but provides context for the request;

64. The method of claim 56 further comprising:
receiving one or more authentication or monitoring requests from an authentication requester, the requests supplying data identifying at least one stored open key;
analyze the one or more authentication requests to determine an authentication result by analyzing one or more of:
one or more authentication rule sets associated with the open key.

65. The method of claim 56 further wherein:
an authentication result transmitted to a user generally indicates one of two authentication states: authenticated or not authenticated.

66. The method of claim 56 further wherein:
an authentication result transmitted to a user generally indicates one of three authentication states: authenticated, not authenticated, or undetermined.

67. The method of claim 56 further comprising:
providing an incentive or reward to a user (such as a customer) for contacting the authentication server to authenticate an item.

68. (canceled)

69. The method of claim 56 further comprising:
configuring the authentication server to:
receive authentication requests and authentication data for an item from multiple levels in a supply chain;
receive authentication requests and item data for an item from multiple actors in a payment transaction;
authenticate the item; and
store an authentication history information for the item in an authentication database.

70. The method of claim 56 further comprising:
configuring the authentication server to:
associate at least one hidden key with an item and storing the hidden key in the authentication database;
receive an authentication request including the hidden key and providing authentication using the hidden key.

71. The method of claim 56 further comprising:
configuring the authentication server to:
associate at least one hidden key with an item and storing the hidden key in the authentication database;
receive an authentication request including the hidden key and as a result thereof,
store in the authentication database that at least one non-reversible action has taken place with respect to the item; and
use the occurrence of the non-reversible action in responding to one or more authentication requests.

72. The method of claim 71 further wherein:
the non-reversible action is one or more selecting from the group consisting of:
opening an end user package;
opening a carton, box, palette, container, or other packaging that may contains one or more packaged or unpackaged items that may be further distributed down a supply chain and further authenticated with one or more further hidden or open keys;
uncovering a key that was hidden by a label, scratch off surface, or otherwise.

73. The method of claim 56 further comprising one or more of the following:
at least one authentication request counter associated with an item in the authentication database; and
at least one authentication request timer associated with an item in the authentication database.

74. The method of claim 56 further wherein authentication can take into account one or more of:
an item'open key;
an item's hidden key;
an item's serial number;
time of authentication request;
geographical location of requester;
number of authentication requests previously received for an item;
time between authentication requests for an item; and
expiration date associated with an item.

75. The method of claim 70 further comprising one or more of the following:
at least one authentication request counter associated with a hidden key in the authentication database; and
at least one authentication request timer associated with a hidden key in the authentication database.

76. The method of claim 70 further comprising:
an authentication requester sending an open key and a hidden key for an item to the authentication server;
the authentication server using the keys to query the authentication database;
if the open key is not in the database, a reply is sent to the authentication requester notifying the requester that item is not registered in the database (e.g. it may be counterfeit);
if the open key is in the database, the authentication database is then queried using the hidden key;
if the hidden key is not in the database, a reply is sent to the authentication requester notifying the requester that item is not registered in the database or that it is counterfeit.

77. A method according to claim 70 further comprising one or more of the following:
wherein the stored hidden key and the item hidden key are effectively the same;
wherein the stored hidden key and the item hidden key are related by encryption or some other algorithm or method that is performed at the server;
wherein the stored open key and the item open key are effectively the same;
wherein the stored open key and the item open key are related by encryption or some other algorithm or method that is performed at the server.

78. A method according to claims 70 further comprising one or more of the following:
a supplier, e.g., a manufacture, producer, assembler or distributor, labels a finished or partial item with one or more open keys, of which at least one open key is unique to that item.

79. The method of claim 70 wherein all open keys are unique to the item.

80. The method of claim 70 wherein open keys comprise one or more of:
a sequence of alphanumeric characters;
one or more other characters or symbols;
a product serial number; and
a barcode, QR code, RFID, or other code or tag or identification mark.

81. (canceled)

82. The method of claim 70 further comprising one or more of the following:
wherein hidden keys are not visible to a casual observer of an item;
wherein at least one hidden key is unique to a particular item;
wherein multiple items are associated with a particular hidden key;
wherein hidden keys comprise a sequence of alphanumeric characters but other characters or symbols can be used such as punctuation marks or barcodes;
wherein hidden keys are placed on or in close proximity to the item, e.g., inside a sealed box containing the item (e.g. printed characters or symbols associated with an item);
wherein hidden keys are associated with items or transactions that are not physically associated with an item.

83. The method of claim 70 further comprising one or more of the following:
the hidden key is printed on, inserted into, or attached to the inside of an item, such as a closed compartment of a refrigerator;
the hidden key is attached to, affixed, or printed on the item and the hidden key is concealed from plain view through the use of an opaque protective covering such as a scratch off covering, a tear off covering, or other tamper evident covering;
the hidden key is attached to, affixed or printed on a component or subcomponent of the item and the hidden key is concealed from plain view by the finished assembled item;
the hidden key is inserted into, affixed to, or incorporated into a container or closure that holds the item and the sealed container or closure hides the hidden key from plain view;
the hidden key may be printed or affixed to the inside of a box or other form of packaging the holds the item;
the hidden key is printed or affixed to the outside of the box or package and is concealed from plain view through the use of an opaque protective covering such as a scratch off covering, a tear off covering or other tamper evident covering;
the hidden key is inserted into, affixed to, or incorporated into a product insert that may be placed inside a bottle or box containing the item
further wherein the product insert is a warranty or registration card, or operating instructions;
one or more hidden keys are shared among a plurality of individual items.

84. The method of claim 70 further comprising one or more of the following:
a supply chain that comprises at least four distribution levels, e.g., a goods manufacturer (Level 1), a wholesaler (Level 2), a retailer (Level 3) and a consumer (Level 4);
the supply chain is of any length.

85. The method of claim 70 further wherein the authentication database is configured to comprise one or more of:
administrator information, original manufacturer or supplier information, product name, product category, model number, lot number, serial number, production run, date of manufacture, lot number, expiration date, release or testing results, release date, other product description information, invoice number, shipping time and date, shipping waybill number, shipping agent, shipping route, receiving party's name and address, shipping insurance information, insurance coverage, open keys, hidden keys, authentication counters, dates and times of authentication requests, number of successful authentication requests, geographical locations of authentication requesters, internet protocol addresses (WA) of authentication requesters, and/or return messages.

86. (canceled)

87. A system for monitoring one or more items in a supply chain comprising:
an authentication database in an authentication server, said authentication server including at least one processor, at least one memory, and at least one communication interface,
wherein the authentication database is configured to store data values associated with the one or more items in the supply chain;
wherein the data values associated with an item comprise:
at least one stored open key;
at least one stored open key associated with an item placed in a supply chain;
wherein the authentication server is specifically configured to:
receive one or more authentication or monitoring requests from an authentication requester (e.g. a supply chain user), the requests supplying data identifying at least one stored open key;
analyze the one or more authentication or monitoring request to determine an authentication result by analyzing one or more of:
one or more authentication rule sets associated with the open key;
data regarding the item stored at the database when the open key was initially stored;
data regarding the item stored at the database as a result of additional data received at the database;
data regarding one or more previous monitoring or authentication requests;
data regarding time of request, location from which request was received, or other data regarding the request that is generally independent of the item or open key but provides context for the request;
transmit one or more authentication results to the authentication requester;
update the authentication database to reflect the request; and
optionally transmit authentication data and/or additional data to a supply chain monitor.

88. The system of claim 87 further comprising:
at least one portable or fixed authentication device, said at least one authentication device including at least one processor, at least one memory, and at least one communication interface,
wherein the authentication device is specifically configured to:
scan or read open keys and optionally hidden keys attached to or associated with items;
transmit open keys and optionally hidden keys to the authentication server;
receive an authentication result from the authentication server; and
take an appropriate action at a user location comprising one or more of:
presenting the authentication result to a user;
confirming a transaction;
processing a payment.
